(19) United States
(12) Patent Application Publication
(10) Pub. No.: US 2025/0386325 A1
(43) Pub. Date: Dec. 18, 2025

(54) PAGING RECEPTION AND TRANSMISSION

(71) Applicant: Samsung Electronics Co., Ltd., Suwon-si (KR)

(72) Inventors: Anil Agiwal, McKinney, TX (US); Kyeongin Jeong, Frisco, TX (US); Shiyang Leng, Little Elm, TX (US)

(21) Appl. No.: 19/204,276

(22) Filed: May 9, 2025

Related U.S. Application Data
(60) Provisional application No. 63/659,142, filed on Jun. 12, 2024.
(60) Provisional application No. 63/671,413, filed on Jul. 15, 2024.
(60) Provisional application No. 63/672,068, filed on Jul. 16, 2024.
(60) Provisional application No. 63/679,414, filed on Aug. 5, 2024.
(60) Provisional application No. 63/701,124, filed on Sep. 30, 2024.

(51) Int. Cl. H04W 68/02; H04L 1/08; H04W 72/1273; H04W 72/232

(52) U.S. Cl. CPC H04W 68/02; H04L 1/08; H04W 72/1273; H04W 72/232

(57) ABSTRACT

A user equipment (UE) includes a transceiver configured to receive, from a base station (BS), during a paging occasion (PO), first downlink control information (DCI) addressed to a paging radio network temporary identifier (P-RNTI), and receive, from the BS, a downlink (DL) transport block (TB) for paging scheduled by the first DCI. The UE also includes a processor operably coupled to the transceiver. The processor is configured to decode the DL TB for paging, determine whether the DL TB for paging is successfully decoded, and in response to a determination that the DL TB for paging is not successfully decoded, cause the transceiver to transmit, to the BS, a request for a paging retransmission.

### CROSS-REFERENCE TO RELATED APPLICATIONS AND CLAIM OF PRIORITY

This application claims priority under 35 U.S.C. § 119(e) to U.S. Provisional Patent Application No. 63/659,142 filed on Jun. 12, 2024, U.S. Provisional Patent Application No. 63/671,413 filed on Jul. 15, 2024, U.S. Provisional Patent Application No. 63/672,068 filed on Jul. 16, 2024, U.S. Provisional Patent Application No. 63/679,414 filed on Aug. 5, 2024, and U.S. Provisional Patent Application No. 63/701,124 filed on Sep. 30, 2024. The above-identified provisional patent applications are hereby incorporated by reference in their entirety.

### TECHNICAL FIELD

This disclosure relates generally to wireless networks. More specifically, this disclosure relates to paging reception and transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for paging reception and transmission.

In one embodiment, a user equipment (UE) is provided. The UE includes a transceiver configured to receive, from a base station (BS), during a paging occasion (PO), first downlink control information (DCI) addressed to a paging radio network temporary identifier (P-RNTI), and receive, from the BS, a downlink (DL) transport block (TB) for paging scheduled by the first DCI. The UE also includes a processor operably coupled to the transceiver. The processor is configured to decode the DL TB for paging, determine whether the DL TB for paging is successfully decoded, and in response to a determination that the DL TB for paging is not successfully decoded, cause the transceiver to transmit, to the BS, a request for a paging retransmission.

In another embodiment, a method of operating a UE is provided. The method includes receiving, from BS, during a PO, first DCI addressed to a P-RNTI, and receiving, from the BS, a DL TB for paging scheduled by the first DCI. The method also includes decoding the DL TB for paging, determining whether the DL TB for paging is successfully decoded, and in response to a determination that the DL TB for paging is not successfully decoded, transmitting, to the BS, a request for a paging retransmission.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for paging at a UE according to embodiments of the present disclosure;

FIG. 5 illustrates an example of scheduling of multiple paging messages by PDCCH addressed to P-RNTI in a PO according to embodiments of the present disclosure;

FIG. 6 illustrates an example procedure for paging at a gNB according to embodiments of the present disclosure;

FIG. 7 illustrates another example procedure for paging at a UE according to embodiments of the present disclosure;

FIG. 8 illustrates another example procedure for paging at a UE according to embodiments of the present disclosure;

FIG. 9 illustrates an example of mapping PDCCH monitoring occasions configured in both a time domain and a frequency domain to a PO according to embodiments of the present disclosure;

FIG. 10 illustrates another example of mapping PDCCH monitoring occasions configured in both a time domain and a frequency domain to a PO according to embodiments of the present disclosure;

FIG. 11 illustrates an example of numbering PDCCH monitoring occasions for paging and mapping the PDCCH monitoring occasions configured in both a time domain and a frequency domain to a PO according to embodiments of the present disclosure;

FIG. 12 illustrates another example of numbering PDCCH monitoring occasions for paging and mapping the PDCCH monitoring occasions configured in both a time domain and a frequency domain to a PO according to embodiments of the present disclosure;

FIG. 13 illustrates another example procedure for paging at a UE according to embodiments of the present disclosure;

FIG. 14 illustrates an example of feedback based paging according to embodiments of the present disclosure;

FIG. 15 illustrates another example of feedback based paging according to embodiments of the present disclosure;

FIG. 16 illustrates another example of feedback based paging according to embodiments of the present disclosure;

FIG. 17 illustrates an example of PMOs to PO mapping according to embodiments of the present disclosure;

FIG. 18 illustrates another example of PMOs to PO mapping according to embodiments of the present disclosure;

FIG. 19 illustrates another example of PMOs to PO mapping according to embodiments of the present disclosure;

FIG. 20 illustrates another example of feedback based paging according to embodiments of the present disclosure;

FIG. 21 illustrates another example of feedback based paging according to embodiments of the present disclosure;

FIG. 22 illustrates an example method for operating a UE according to embodiments

of the present disclosure;

FIG. 23 illustrates another example method for operating a UE according to embodiments of the present disclosure;

FIG. 24 illustrates another example method for operating a UE according to embodiments of the present disclosure; and

FIG. 25 illustrates an example method for paging reception and transmission according to embodiments of the present disclosure.

### DETAILED DESCRIPTION

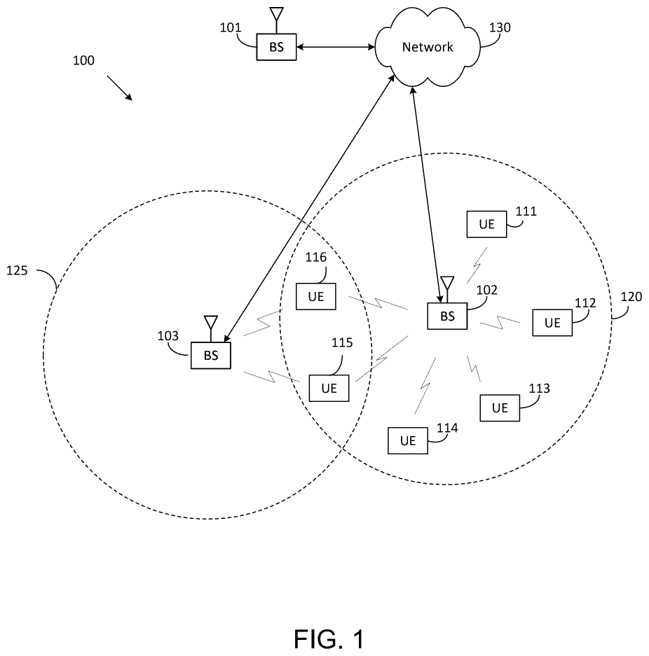

FIGS. 1 through 25, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for paging reception and transmission. In certain embodiments, one or more of the gNBs 101-103 includes circuitry, programing, or a combination thereof, to support paging reception and transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

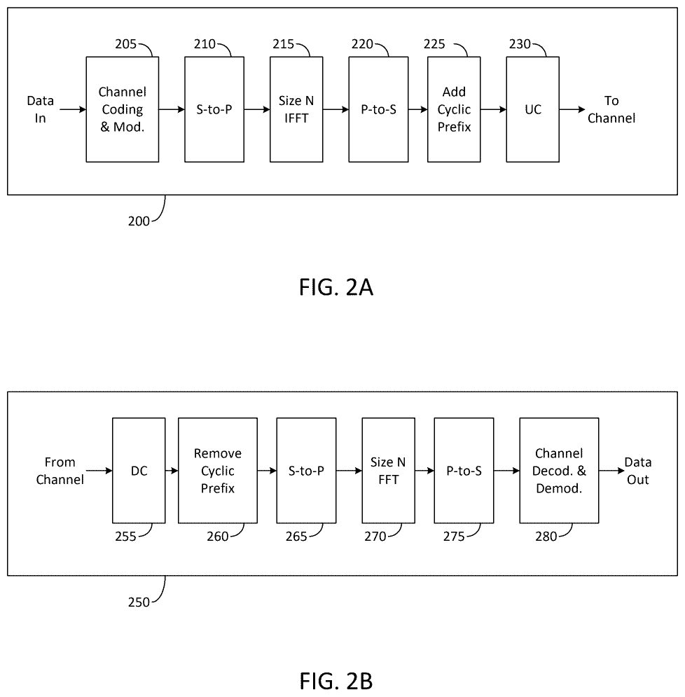

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support paging reception and transmission as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

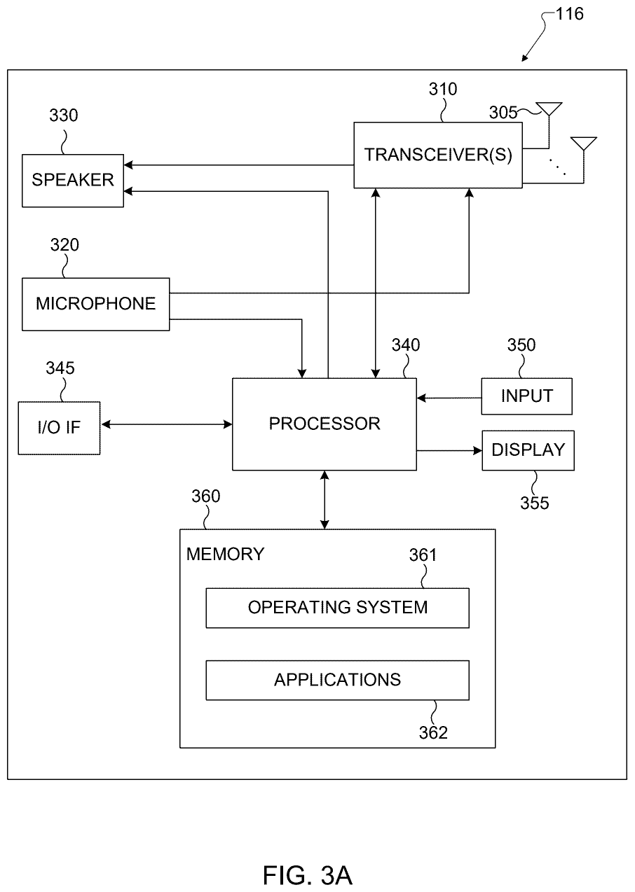

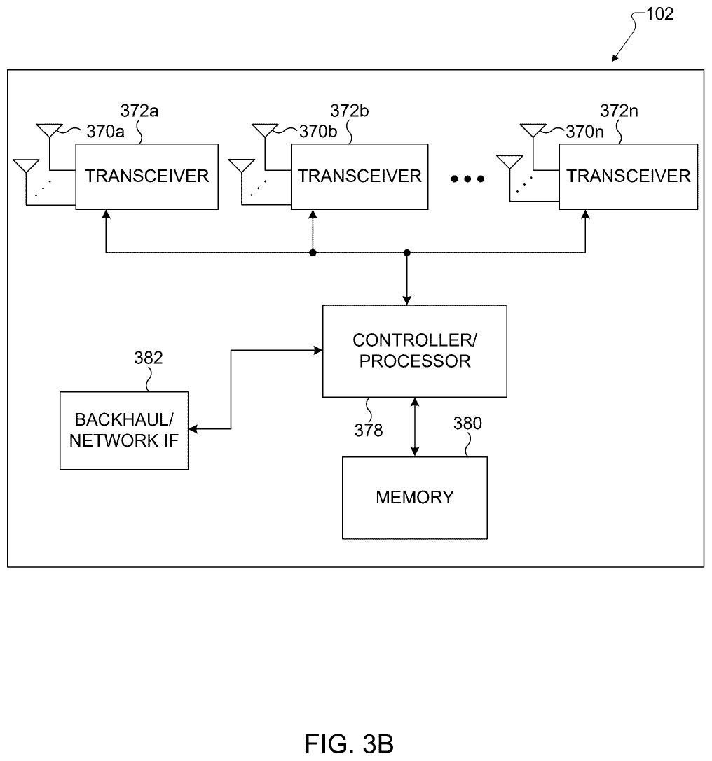

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for paging reception and transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support paging reception and transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or positioning SIBs (posSIBs) having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID). The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve UL time synchronization. RA is used during initial access, handover, RRC connection re-establishment procedure, scheduling request transmission, SCG addition/modification, beam failure recovery and data or control information transmission in the UL by a non-synchronized UE in RRC CONNECTED state. Several types of RA procedures are supported, such as contention based random access, and contention free random access. Each of these can be one of 2 step or 4 step random access.

In the next generation wireless communication system (e.g., 5G, beyond 5G, 6G). A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + \text{} x - Monitoring - offset - PDDCH - slot ) \text{} mod ( Monitoring - periodicity - PDDCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SC). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-Inactivity Timer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G (B5G), 6G), a UE can be in one of the following RRC states: RRC IDLE, RRC INACTIVE and RRC CONNECTED. Paging allows the network to reach UEs in the RRC_IDLE and in RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with a paging radio network terminal identifier (P-RNTI) on the PDCCH, but while the former is sent on a paging common logical channel (PCCH) (a transport block [TB] carrying the paging message is transmitted over the PDSCH [Physical downlink shared channel])), the latter is sent over the PDCCH directly.

While in the RRC_IDLE state, the UE monitors the paging channels for core network (CN)-initiated paging. While in the RRC_INACTIVE state, the UE monitors paging channels for radio access network (RAN)-initiated paging and CN-initiated paging. A UE need not monitor paging channels continuously though. Paging discontinuous reception (DRX) is defined where the UE in the RRC_IDLE or RRC_INACTIVE state is only required to monitor paging channels during one Paging Occasion (PO) per DRX cycle.

A PO is a set of PDCCH monitoring occasions and can comprise multiple time slots (e.g., subframes or OFDM symbols) where paging DCI (i.e., PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams, and thus the selection of the beam(s) for the reception of the paging message and Short Message is up to UE implementation. The paging message is the same for both RAN initiated paging and CN initiated paging. The UE initiates the RRC Connection Resume procedure upon receiving RAN initiated paging. If the UE receives a CN initiated paging in the RRC_INACTIVE state, the UE moves to the RRC_IDLE state and informs the network access stratum (NAS).

The PF and PO for paging are determined (by the UE and base station e.g., gNB) by the following formulae:
System frame number (SFN) for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for RMSI (or SIB1).

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)^{th} PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
If the UE operates in enhanced DRX (eDRX):
   5G-S-TMSI (5G serving temporary mobile subscriber identity) mod 4096 otherwise:
   5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated PEI (Paging Early Indication). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in the cell which supports CN assigned subgrouping. A UE supporting CN assigned subgrouping in the RRC_IDLE or RRC_INACTIVE state can be assigned a subgroup ID (between 0 to 7) by an access and mobility management function (AMF) through NAS signaling.

If the UE is not configured with a CN assigned subgroup ID, or if the UE configured with a CN assigned subgroup ID is in a cell supporting only UE_ID based subgrouping, the subgroup ID of the UE is determined by the formula below:

$$SubgroupID = ( floor ( UE\_ID / ( N * Ns ) ) mod subgroupsNumForUEID ) + ( subgroupsNumPerPO - subgroupsNumForUEID ) ,$$

where:
N: number of total paging frames in T, which is the DRX cycle of RRC_IDLE state
Ns: number of paging occasions for a PF
UE_ID: 5G-S-TMSI mod X, where X is 32768, if eDRX is applied; otherwise, X is 8192
subgroupsNumForUEID: number of subgroups for UE_ID based subgrouping in a PO, which is broadcasted in system information.

The UE monitors one PEI occasion per DRX cycle. A PEI occasion (PEI-O) is a set of PDCCH monitoring occasions (MOs) and can comprise multiple time slots (e.g., subframes or OFDM symbols) where a PEI can be sent. In multi-beam operations, the UE assumes that the same PEI is repeated in all transmitted beams, and thus the selection of the beam(s) for the reception of the PEI is up to UE implementation. The time location of a PEI-O for the UE's PO is determined by a reference point and an offset:
The reference point is the start of a reference frame determined by a frame-level offset from the start of the first PF of the PF(s) associated with the PEI-O, provided by pei-FrameOffset in SIB1; The first PF of the PFs associated with the PEI-O is provided by (SFN for PF)−floor(i_{PO}/Ns)*T/N; where

$${i}_{PO} = ( ( UE\_IDmodN ) \cdot {N}_{s} + i\_s ) {modN}_{PO}^{PEI}$$

is a paging occasion index,

$${N}_{PO}^{PEI} ,$$

is signaled by po-NumPerPEI.
The offset is a symbol-level offset from the reference point to the start of the first PDCCH MO of this PEI-O, provided by firstPDCCH-MonitoringOccasionOfPEI-O in SIB1.

In existing wireless communication systems, several PFs and/or POs are configured by the network in a DRX cycle. UEs are distributed across these PFs/POs. Each UE monitors one PF/PO per DRX cycle. Multiple UEs monitor the same PF/PO.

More PFs/POs result in more PDCCH overhead (such as cyclic redundancy check [CRC]) and network energy consumption, as the network has to transmit PDCCH and PDSCH separately for each PO. For instance, consider an example where there are 4 PFs in a DRX cycle and each PF has one PO. In this example: (i) UEs with UE_ID 0 to 255 monitor the PO in PF1, (ii) UEs with UE_ID 256 to 511 monitor the PO in PF2, (iii) UEs with UE ID 512 to 767 monitor the PO in PF3, and (iv) UEs with UE_ID 768 to 1023 monitor the PO in PF4. In these circumstances, if there is paging for UE_ID 0, UE_ID 256, UE_ID 512 and UE_ID 768, the network has to send a PDCCH and a PDSCH including a paging message in the PO of PF1 to PF4, with each paging message including paging for one UE. Note that in this example, even though each paging message has capacity to include paging for more UEs, the gNB has to send four paging messages. Various embodiments of the present disclosure provide mechanisms for more efficient paging for such situations.

If there is paging for several UEs monitoring a PF/PO, and all of these UEs cannot be paged in the same paging message due to a limitation of paging message size, some UEs would need to be paged in a PF/PO in the next DRX cycle, leading to increased paging latency. Various embodiments of the present disclosure provide mechanisms for reducing paging latency for such situations.

In existing wireless communication systems, a UE monitors one PO per DRX cycle. In cases where there is paging for the UE, the network transmits a PDCCH addressed to a P-RNTI in the UE's PO. The PDCCH schedules a DL TB on the PDSCH, and the scheduled DL TB includes a paging message. If the UE fails to decode the scheduled DL TB, the UE will not respond to paging (e.g., the UE may not initiate connection setup/resume). In cases where the network does not receive a connection setup/resume from the UE, the network can retransmit the paging message in later DRX cycles. This results in increased paging latency. In some cases, a UE may not be in a cell where paging is transmitted, and paging retransmission due to not receiving a response (e.g., connection setup/resume) to the paging from UE may lead to unnecessary signaling overhead. In some cases, paging can be for particular purpose (e.g., to trigger to start receiving multicast data) which does not trigger a response (e.g., connection setup/resume) to the network. Various embodiments of the present disclosure provide mechanisms for reduced paging latency and/or reduced signaling overhead in such cases.

In existing wireless communication systems, a UE can be configured with SSB based radio resource management (RRM) measurement to discover SCell(s) and/or activate SCell(s) and/or deactivate SCell(s) and/or configure SCell(s). For example, the UE may receive an RRCReconfiguration message. The RRCReconfiguration message may include a configuration of an SCell. The configuration of the SCell may indicate a measurement object for the SCell. The measurement object may include a configuration of always-on SSB(s) periodically transmitted in the SCell, and the configuration may include ssbFrequency, ssbSubcarrierSpacing, smtc, ssb-ToMeasure etc. Upon receiving the configuration, the UE may measure the SSBs based on the configuration and the UE reports the RRM measurement results to the gNB on the quality of the measured SSB(s). The periodic transmission of SSBs for the SCell operation affects the network energy consumption. For network energy savings two cases can be considered for on demand SSB transmission in an SCell:
Case #1: No always-on SSB transmission on the cell. Upon an on-demand SSB trigger, SSBs are periodically transmitted.
Case #2: SSBs are periodically transmitted in an SSB burst/window. On-demand SSB transmission can be additionally provided. Note that periodic SSB transmission can be at a longer periodicity to reduce energy consumption, but this affects performance ([re]sync/automatic gain control [AGC] delay, etc.). Additional on demand SSB transmissions can improve performance.

In both Case #1 and Case #2, on-demand SSB based RRM measurement can be beneficial. RRM measurements in the SCell are based on a measurement object. If a measurement object is configured, the UE starts to measure the SSBs configured by the measurement object for RRM upon receiving the configuration.
In Case #1, there is no measurement object configured as per current procedure, so the UE cannot perform RRM measurements on the SCell based on an SSB transmitted in the SCell. Even if a measurement object is configured for Case #1, the UE will start to measure the SSBs configured by the measurement object for RRM upon receiving the configuration under existing procedures. This leads to unnecessary energy consumption at the UE, as the UE performs measurements even when SSBs are not transmitted. To reduce UE energy consumption, various embodiments of the present disclosure provide enhancements for configuration/activation of RRM measurement for SCell operation.
In Case #2, there is a measurement object configured as per current procedure. The UE performs measurement based on an always-on SSB configuration in the measurement object. The UE does not know when and whether to perform RRM measurement based on on-demand SSB transmission. To overcome this issue, various embodiments of the present disclosure provide enhancements for configuration/activation of RRM measurement for SCell operation.

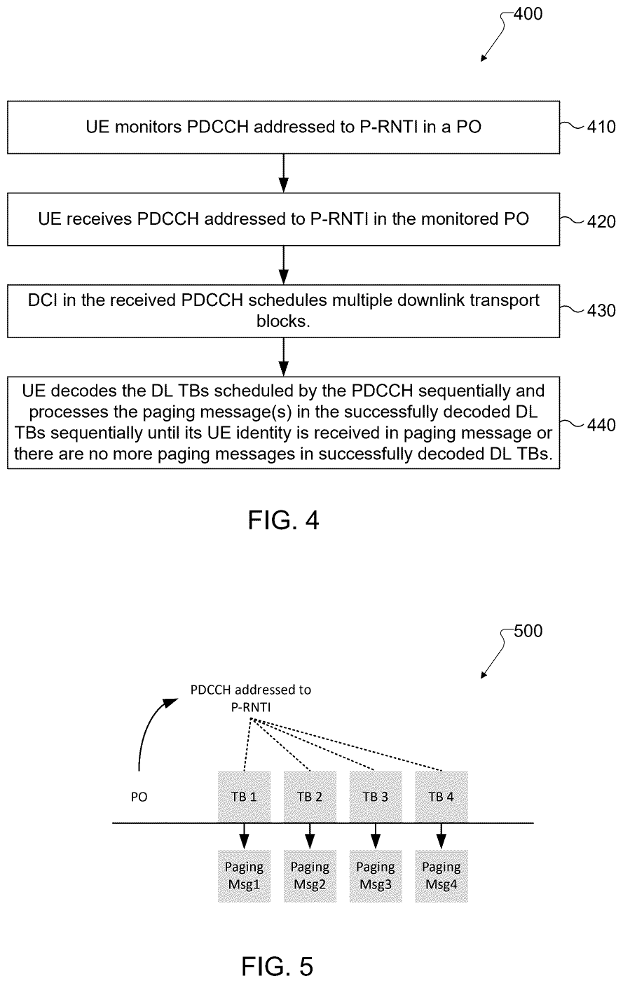

FIG. 4 illustrates an example procedure 400 for paging at a UE according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for paging at a UE could be used without departing from the scope of this disclosure.

In the example of FIG. 4, procedure 400 begins at operation 410. At operation 410, a UE (such as UE 116 of FIG. 1) is in an RRC_IDLE/RRC_INACTIVE state and camped on a cell. The UE monitors a PO in a DRX cycle (i.e., the UE monitors for a PDCCH addressed to a P-RNTI in the PO).

At operation 420, the UE receives a PDCCH addressed to the P-RNTI in the monitored PO from the camped cell.

At operation 430, the DCI in the received PDCCH addressed to the P-RNTI may schedule a plurality of downlink (DL) transport blocks (TBs). Each TB includes a paging message (or multiple paging messages). The TBs may be transmitted on a PDSCH. In some embodiments, the DCI in the received PDCCH addressed to the P-RNTI may indicate the number of scheduled TBs and/or scheduling/resource information for the TBs. In some embodiments, an RRC signaling message (e.g., system information) in the cell may indicate the number of scheduled TBs. In some embodiments, the symbols/slots/subframes/frames in which the TBs are scheduled can be signaled in an RRC signaling message (e.g., system information) or the DCI in the received PDCCH addressed to the P-RNTI. In some embodiments, the offset between slots/subframes/frames in which the TBs are scheduled by the DCI can be signaled in an RRC signaling message (e.g., system information) or the DCI in the received PDCCH addressed to the P-RNTI. In some embodiments, the offset between the end of a symbol/slot/subframe/frame in which the DCI is received and the slot/subframe/frame in which the first TB is scheduled by the DCI can be signaled in an RRC signaling message (e.g., system information) or the DCI in the received PDCCH addressed to the P-RNTI. In some embodiments, the PRBs and/or OFDM symbols in which the TBs are scheduled by the DCI can be signaled in an RRC signaling message (e.g., system information) or the DCI in the received PDCCH addressed to the P-RNTI.

At operation 440, in some embodiments, the UE decodes the DL TBs scheduled by the PDCCH sequentially and processes the paging message(s) in the successfully decoded DL TBs sequentially until the UE's UE identity is received in a paging message or there are no more received paging messages in successfully decoded TBs.

Alternately at operation 440, in some embodiments, the UE decodes DL TBs scheduled by the PDCCH sequentially as follows:
The UE decodes a scheduled DL TB. The UE processes the paging message(s) in the successfully decoded DL TB. The UE sequentially processes each paging message in the successfully decoded DL TB until the UE's UE identity is received in a paging message or there are no more paging messages in the successfully decoded DL TB.
If a paging message including the UE identity is not received in the successfully decoded DL TB, the UE decodes the next scheduled DL TB, if the last decoded DL TB is the not last DL TB scheduled by the PDCCH.

Alternately at operation 440, in some embodiments, the UE decodes all the DL TBs scheduled by the PDCCH. In these embodiments, the UE processes the successfully decoded DL TBs sequentially as follows:
The UE processes the paging message(s) in the successfully decoded DL TB. The UE sequentially processes each paging message in the successfully decoded DL TB until the UE's UE identity is received in a paging message or there are no more paging messages in the successfully decoded DL TB.
If a paging message including the UE identity is not received in the successfully decoded DL TB, the UE processes the next successfully decoded DL TB, if the last successfully decoded DL TB is the not last DL TB scheduled by the PDCCH.

Although FIG. 4 illustrates one example procedure 400 for paging at a UE, various changes may be made to FIG. 4. For example, while shown as a series of operations, various operations in FIG. 4 could overlap, occur in parallel, occur in a different order, occur any number of times, be omitted, or replaced by other operations.

FIG. 5 illustrates an example 500 of scheduling of multiple paging messages by PDCCH addressed to P-RNTI in a PO according to embodiments of the present disclosure. The embodiment of scheduling multiple paging messages by PDCCH addressed to P-RNTI in a PO of FIG. 5 is for illustration only. Different embodiments of scheduling multiple paging messages by PDCCH addressed to P-RNTI in a PO could be used without departing from the scope of this disclosure.

In example 500, which shows scheduling of multiple paging messages by PDCCH addressed to P-RNTI in a PO, DCI in the PDCCH schedules four DL TBs (TBs 1-4). Each TB includes a paging message (i.e., one of Paging Msg1-Msg4). A UE may process the TBs 1 to 4 and paging messages 1 to 4 sequentially (e.g., according to procedure 400 of FIG. 4). If the UE receives the UE's UE identity in paging message 1, the UE does not need to decode TBs 2 to 4 and/or process paging messages 2 to 4. If the UE receives the UE's UE identity in paging message 2, the UE does not need to decode TBs 3 to 4 and/or process paging messages 3 to 4. If the UE receives the UE's UE identity in paging message 3, the UE does not need to decode TB 4 and/or process paging messages 4.

Although FIG. 5 illustrates one example 500 of scheduling multiple paging messages by PDCCH addressed to P-RNTI in a PO, various changes may be made to FIG. 5. For example, various changes to the number of transport blocks, the number of paging messages, etc. could be made according to particular needs.

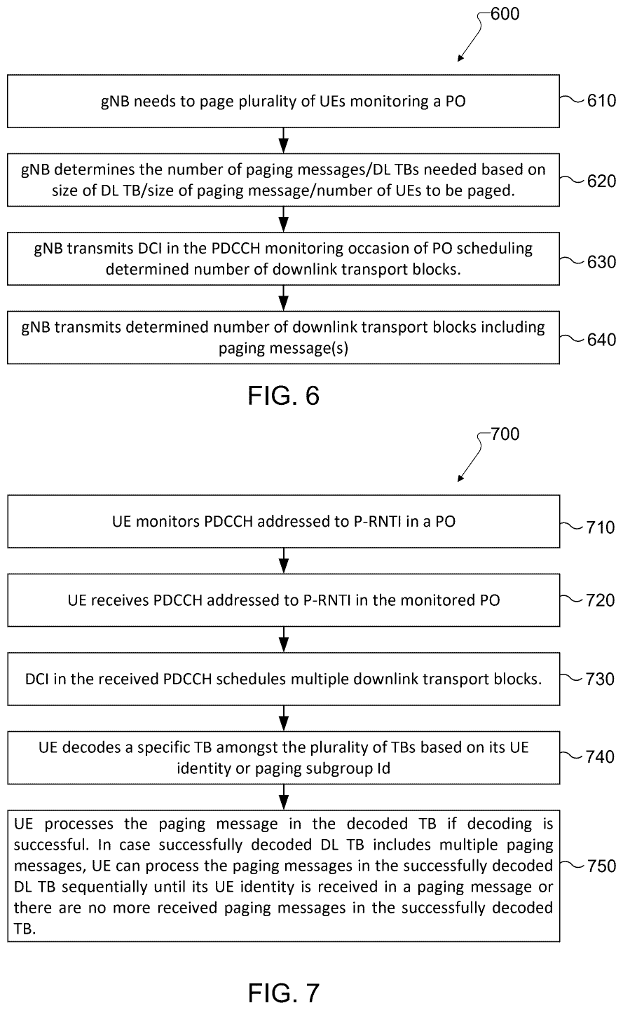

FIG. 6 illustrates an example procedure 600 for paging at a gNB according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for paging at a gNB could be used without departing from the scope of this disclosure.

In the example of FIG. 6, procedure 600 begins at operation 610. At operation 610, a gNB (such as gNB 102 of FIG. 1) needs to page a plurality of UEs monitoring a PO.

At operation 620, the gNB determines the number of paging messages/DL TBs needed based on the size of DL TB/size of paging message/number of UEs to be paged. For example, the number of UEs to be paged may be 32. In this example, one paging message can include up to 16 UE identities. The gNB can determine to transmit two DL TBs, each DL TB including one paging message.

At operation 630, the gNB transmits DCI in the PDCCH monitoring occasion of a PO scheduling the determined number of downlink transport blocks.

At operation 640, the gNB transmits the determined number of downlink transport blocks including paging message(s).

Although FIG. 6 illustrates one example procedure 600 for paging at a gNB, various changes may be made to FIG. 6. For example, while shown as a series of operations, various operations in FIG. 6 could overlap, occur in parallel, occur in a different order, occur any number of times, be omitted, or replaced by other operations.

FIG. 7 illustrates another example procedure 700 for paging at a UE according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for paging at a UE could be used without departing from the scope of this disclosure.

In the example of FIG. 7, procedure 700 begins at operation 710. At operation 710, a UE (such as UE 116 of FIG. 1) is in an RRC_IDLE/RRC_INACTIVE state and camped on a cell. The UE monitors a PO in a DRX cycle (i.e., the UE monitors for a PDCCH addressed to a P-RNTI in the PO).

At operation 720, the UE receives a PDCCH addressed to the P-RNTI in the monitored PO from the camped cell.

At operation 730, the DCI in the received PDCCH addressed to the P-RNTI may schedule a plurality of DL TBs. Each TB includes a paging message (or multiple paging messages). The TBs may be transmitted on a PDSCH. In some embodiments, the DCI in the received PDCCH addressed to the P-RNTI may indicate the number of scheduled TBs and/or scheduling/resource information for the TBs. In some embodiments, an RRC signaling message (e.g., system information) in the cell may indicate the number of scheduled TBs. In some embodiments, the symbols/slots/subframes/frames in which the TBs are scheduled can be signaled in an RRC signaling message (e.g., system information) or the DCI in the received PDCCH addressed to the P-RNTI. In some embodiments, the offset between slots/subframes/frames in which the TBs are scheduled by the DCI can be signaled in an RRC signaling message (e.g., system information) or the DCI. In some embodiments, the offset between the end of a symbol/slot/subframe/frame in which the DCI is received and the slot/subframe/frame in which the first TB is scheduled by the DCI can be signaled in an RRC signaling message (e.g., system information) or the DCI in the received PDCCH addressed to the P-RNTI. In some embodiments, the PRBs and/or OFDM symbols in which the TBs are scheduled by the DCI can be signaled in an RRC signaling message (e.g., system information) or the DCI in the received PDCCH addressed to the P-RNTI.

At operation 740, the UE decodes a specific TB amongst the plurality of TBs based on the UE's UE identity or paging subgroup ID. In some embodiments, a mapping between the TB and the UE identity can be signaled in the DCI or an RRC message. In some embodiments, a mapping between the TB and a paging subgroup ID can be signaled in the DCI or an RRC message. In some embodiments, the number of TBs is equal to the number of paging subgroups, and for an i^{th} paging subgroup ID, the UE decodes the i^{th} DL TB. In some embodiments, the number of TBs may be smaller than the number of paging subgroups, and the UE decodes the i^{th} DL TB, where i=paging subgroup ID mod ‘number of TBs’. In some embodiments, the number of TBs may be smaller than the number of paging subgroups, and the UE decodes the i^{th} DL TB, where i=UE_ID mod ‘number of TBs’. In some embodiments, the number of TBs may be smaller than the number of paging subgroups, and the UE decodes the i^{th} DL TB, where i=(floor(UE_ID/(N*Ns)) mod ‘number of TBs’, and where N is the number of PFs and Ns is number of POs configured by the gNB via RRC or system information.

At operation 750, the UE processes the paging message in the decoded TB if decoding is successful. In case a successfully decoded DL TB includes multiple paging messages, the UE can process the paging messages in the successfully decoded DL TB sequentially until the UEs UE identity is received in a paging message or there are no more received paging messages in the successfully decoded TB.

Although FIG. 7 illustrates one example procedure 700 for paging at a UE, various changes may be made to FIG. 7. For example, while shown as a series of operations, various operations in FIG. 7 could overlap, occur in parallel, occur in a different order, occur any number of times, be omitted, or replaced by other operations.

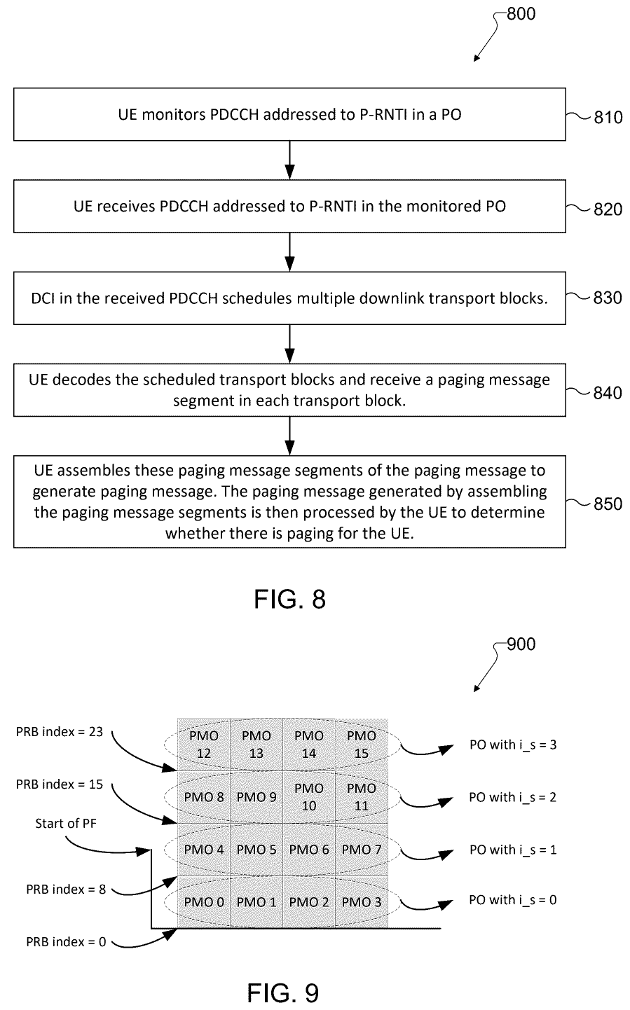

FIG. 8 illustrates another example procedure 800 for paging at a UE according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for paging at a UE could be used without departing from the scope of this disclosure.

In the example of FIG. 8, procedure 800 begins at operation 810. At operation 810, a UE (such as UE 116 of FIG. 1) is in an RRC_IDLE/RRC_INACTIVE state and camped on a cell. The UE monitors a PO in a DRX cycle (i.e., the UE monitors for a PDCCH addressed to a P-RNTI in the PO).

At operation 820, the UE receives a PDCCH addressed to the P-RNTI in the monitored PO from the camped cell.

At operation 830 the DCI in the received PDCCH addressed to the P-RNTI may schedule a plurality of DL TBs. Each TB includes a segment of a paging message. The TBs may be transmitted on a PDSCH. In some embodiments, the DCI may indicate the number of scheduled TBs and/or scheduling/resource information for the TBs. In some embodiments, an RRC signaling message (e.g., system information) in the cell may indicate the number of scheduled TBs. In some embodiments, the symbols/slots/subframes/frames in which the TBs are scheduled can be signaled in an RRC signaling message (e.g., system information) or the DCI in the received PDCCH addressed to the P-RNTI. In some embodiments, the offset between slots/subframes/frames in which the TBs are scheduled by the DCI can be signaled in an RRC signaling message (e.g., system information) or the DCI in the received PDCCH addressed to the P-RNTI. In some embodiments, the offset between the end of a symbol/slot/subframe/frame in which the DCI is received and the slot/subframe/frame in which the first TB is scheduled by the DCI can be signaled in an RRC signaling message (e.g., system information) or the DCI in the received PDCCH addressed to the P-RNTI. In some embodiments, the PRBs and/or OFDM symbols in which the TBs are scheduled by the DCI can be signaled in an RRC signaling message (e.g., system information) or the DCI in the received PDCCH addressed to the P-RNTI.

At operation 840, the UE decodes the scheduled transport blocks and receive a paging message segment in each transport block.

At operation 850, the UE assembles these paging message segments of the paging message to generate paging message. The paging message generated by assembling the paging message segments is then processed by UE to determine whether there is paging for the UE.

Although FIG. 8 illustrates one example procedure 800 for paging at a UE, various changes may be made to FIG. 8. For example, while shown as a series of operations, various operations in FIG. 8 could overlap, occur in parallel, occur in a different order, occur any number of times, be omitted, or replaced by other operations.

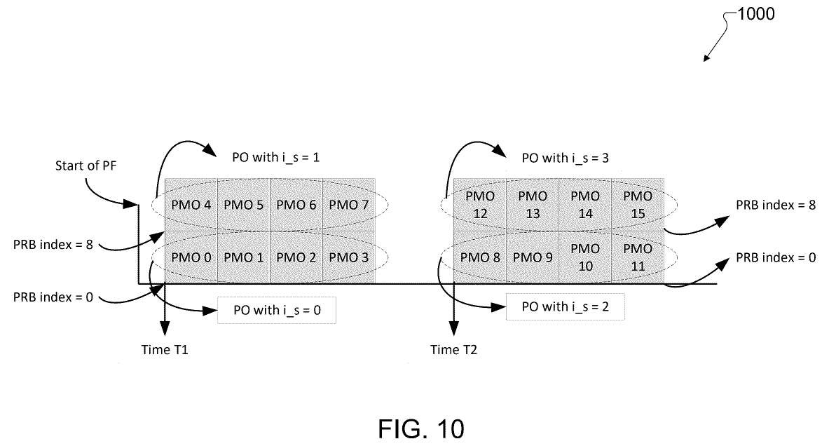

Multiple POs with respect to a PF can be frequency division multiplexed (FDMed). PDCCH monitoring occasions for paging in a PO are time division multiplexed (TDMed). PDCCH monitoring occasions (PMOs) can be configured by paging search space in both the time domain and frequency domain. As shown in FIG. 9 and FIG. 10, PDCCH monitoring occasions for paging can exist in both the time and frequency domain.

As discussed herein regarding FIG. 9, and FIG. 10, a PO refers to a set of ‘S*X’ consecutive PDCCH monitoring occasions in time, where S is the number of transmitted SSBs, and X is the number of PMOs per SSB. The PMOs or valid PMOs are sequentially numbered, wherein ‘S*X’ PMOs in time are numbered in increasing order of a starting PRB index of PMOs (or wherein ‘S*X’ PMOs in time are numbered in increasing order of frequency resource indexes of PMOs).

FIG. 9 illustrates an example 900 of mapping PDCCH monitoring occasions configured in both a time domain and a frequency domain to a PO according to embodiments of the present disclosure. The embodiment of mapping PDCCH monitoring occasions of FIG. 9 is for illustration only. Different embodiments of mapping PDCCH monitoring occasions configured in both a time domain and a frequency domain to a PO could be used without departing from the scope of this disclosure.

In example 900, a PO is a set of ‘S*X’ consecutive PDCCH monitoring occasions, and ‘S*X’ is equal to 4, where S is the number of transmitted SSBs and X is the number of PMOs per SSB. The number of POs per PF is 4 (i_s=0 to 3). The PMOs or valid PMOs are sequentially numbered, wherein ‘S*X’ PMOs in time are numbered in increasing order of starting PRB index of PMOs. Four PMOs, each starting with PRB index 0 in the frequency domain are first numbered sequentially from 0 to 3. Four PMOs, each starting with PRB index 8 in the frequency domain are then numbered sequentially from 4 to 7. Four PMOs, each starting with PRB index 15 in the frequency domain are then numbered sequentially from 8 to 11. Four PMOs, each starting with PRB index 23 in the frequency domain are then numbered sequentially from 12 to 15. The starting PDCCH monitoring occasion number of (i_s+1)^{th} PO is equal to i_s*S*X.

A UE may determine a PF and PO index i_s as described earlier herein. The UE may determine the PMOs of its PO as described above and monitor the PMOs of the determined PO for paging.

Although FIG. 9 illustrates one example 900 of mapping PDCCH monitoring occasions configured in both a time domain and a frequency domain to a PO, various changes may be made to FIG. 9. For example, various changes to the number of PMOs, the PRB indexes, etc. could be made according to particular needs.

FIG. 10 illustrates another example 1000 of mapping PDCCH monitoring occasions configured in both a time domain and a frequency domain to a PO according to embodiments of the present disclosure. The embodiment of mapping PDCCH monitoring occasions of FIG. 10 is for illustration only. Different embodiments of mapping PDCCH monitoring occasions configured in both a time domain and a frequency domain to a PO could be used without departing from the scope of this disclosure.

In example 1000, a PO is a set of ‘S*X’ PDCCH monitoring occasions, and ‘S*X’ is equal to 4, where S is the number of transmitted SSBs and X is the number of PMOs per SSB. The number of POs per PF is 4 (i_s=0 to 3). The PMOs or valid PMOs are sequentially numbered starting from zero, wherein ‘S*X’ PMOs in time are numbered in increasing order of starting PRB index of PMOs. A set of four PMOs in time starting at T1, including the PMO starting with PRB index 0 in the frequency domain are first numbered sequentially from 0 to 3. A set of four PMOs in time starting at T1, including the PMO starting with PRB index 8 in the frequency domain are then numbered sequentially from 4 to 7. A set of four PMOs in time starting at T2, including the PMO starting with PRB index 15 in the frequency domain are then numbered sequentially from 8 to 11. A set of four PMOs in time starting at T2, including PMO starting with PRB index 23 in the frequency domain are then numbered sequentially from 12 to 15. The starting PDCCH monitoring occasion number of (i_s+1)^{th} PO is equal to i_s*S*X.

A UE may determine a PF and PO index i_s as described earlier herein. The UE may determine the PMOs of its PO as explained above and monitor the PMOs of the determined PO for paging.

Although FIG. 10 illustrates one example 1000 of mapping PDCCH monitoring occasions configured in both a time domain and a frequency domain to a PO, various changes may be made to FIG. 10. For example, various changes to the number of PMOs, the PRB indexes, etc. could be made according to particular needs.

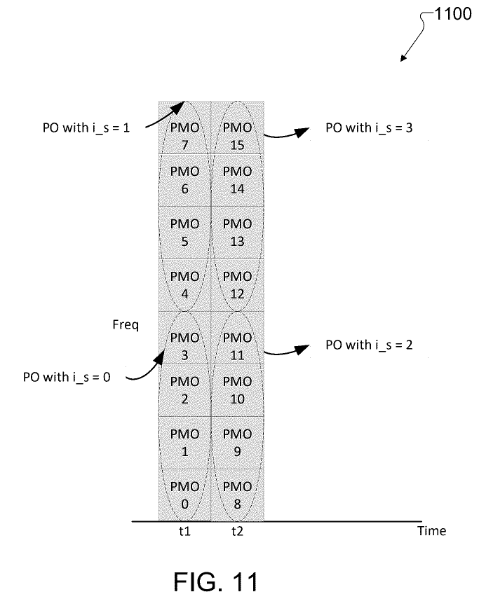

Multiple POs with respect to a PF can be FDMed. PDCCH monitoring occasions for paging in PO are FDMed. PMOs can be configured by paging search space in both the time domain and frequency domain. As shown in FIG. 11, PDCCH monitoring occasions for paging can exist in both the time and frequency domain. PDCCH monitoring occasions for paging (or valid PDCCH monitoring occasions for paging) occurring from the start of paging frame may be sequentially numbered first in frequency and then in time.

As discussed herein regarding FIG. 11, a PO refers a set of ‘S*X’ consecutive PDCCH monitoring occasions for paging (which are sequentially numbered), where S is the number of transmitted SSBs, and X is the number of PMOs per SSB.

FIG. 11 illustrates an example 1100 of numbering PDCCH monitoring occasions for paging and mapping the PDCCH monitoring occasions configured in both a time domain and a frequency domain to a PO according to embodiments of the present disclosure. The embodiment of numbering PDCCH monitoring occasions for paging and mapping the PDCCH monitoring occasions of FIG. 11 is for illustration only. Different embodiments of numbering PDCCH monitoring occasions for paging and mapping the PDCCH monitoring occasions configured in both a time domain and a frequency domain.

In example 1100, there are 16 PDCCH monitoring occasions for paging, in which there are 8 FDMed PDCCH monitoring occasions for paging at time t1 and there are 8 FDMed PDCCH monitoring occasions for paging at time t2. These are sequentially numbered from 0 to 15, starting with PMOs at time t1 and then PMOs at time t2. FDMed PMOs at t1 and t2 are sequentially numbered starting with the PMO occurring first in frequency (i.e., the PMO starting from the lowest PRB). In example 1100, a PO is a set of ‘S*X’ PDCCH monitoring occasions, and ‘S*X’ is equal to 4, where S is the number of transmitted SSB, and X is the number of PMOs per SSB. The number of POs per PF is 4 (i_s=0 to 3). The PO where i_s equals 0 includes PMOs 0 to 3. The PO where i_s equals 1 includes PMOs 4 to 7. The PO where i_s equals 2 includes PMOs 8 to 11. The PO where i_s equals 3 includes PMOs 12 to 15.

Although FIG. 11 illustrates one example 1100 of numbering PDCCH monitoring occasions for paging and mapping the PDCCH occasions configured in both a time domain and a frequency domain to a PO, various changes may be made to FIG. 11. For example, various changes to the number of PMOs, the PRB indexes, etc. could be made according to particular needs.

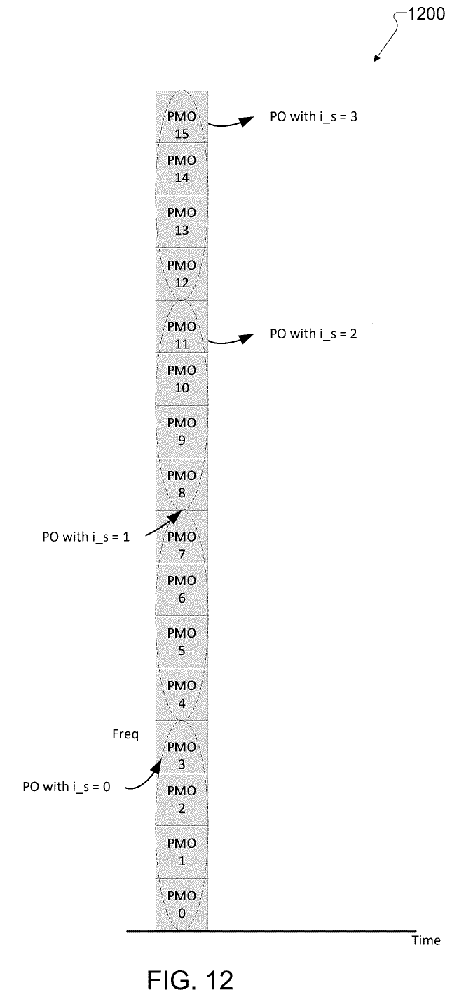

FIG. 12 illustrates another example 1200 of numbering PDCCH monitoring occasions for paging and mapping the PDCCH monitoring occasions configured in both a time domain and a frequency domain to a PO according to embodiments of the present disclosure. The embodiment of numbering PDCCH monitoring occasions for paging and mapping the PDCCH monitoring occasions of FIG. 12 is for illustration only. Different embodiments of numbering PDCCH monitoring occasions for paging and mapping the PDCCH monitoring occasions configured in both a time domain and a frequency domain could be used without departing from the scope of this disclosure.

In example 1200, there are 16 PDCCH monitoring occasions for paging, in which there are 16 FDMed PDCCH monitoring occasions for paging at time t1. These are sequentially numbered from 0 to 15, starting with the PMO occurring first in frequency (i.e., the PMO starting from lowest PRB). In example 1200, a PO is a set of ‘S*X’ PDCCH monitoring occasions, and ‘S*X’ is equal to 4, where S is the number of transmitted SSBs, and X is the number of PMOs per SSB. The number of POs per PF is 4 (i_s=0 to 3). The PO where i_s equals 0 includes PMOs 0 to 3. The PO where i_s equals 1 includes PMOs 4 to 7. The PO where i_s equals 2 includes PMOs 8 to 11. The PO where i_s equals 3 includes PMOs 12 to 15.

A UE may determine a PF and PO index i_s as described earlier herein. The UE may determine the PMOs of its PO as explained above and monitor the PMOs of the determined PO for paging.

Although FIG. 12 illustrates one example 1200 of numbering PDCCH monitoring occasions for paging and mapping the PDCCH occasions configured in both a time domain and a frequency domain to a PO, various changes may be made to FIG. 12. For example, various changes to the number of PMOs, the PRB indexes, etc. could be made according to particular needs.

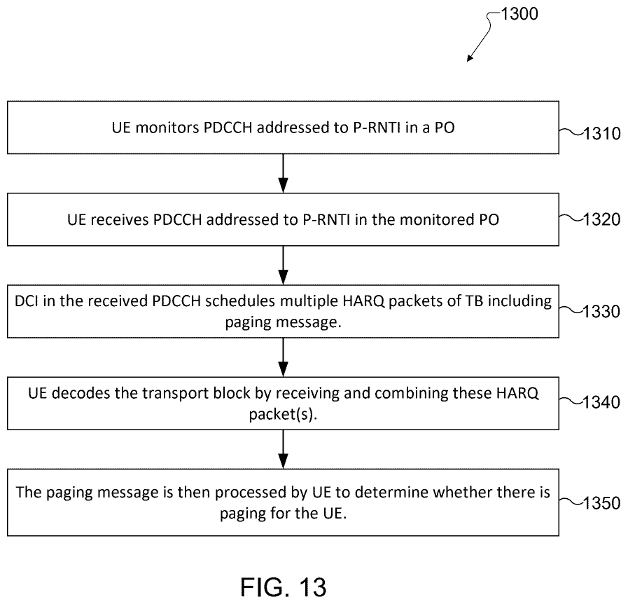

FIG. 13 illustrates another example procedure 1300 for paging at a UE according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for paging at a UE could be used without departing from the scope of this disclosure.

In the example of FIG. 13, procedure 1300 begins at operation 1310. At operation 1310, a UE (such as UE 116 of FIG. 1) is in an RRC_IDLE/RRC_INACTIVE/RRC_CONNECTED state and camped on a cell. The UE monitors a PO in a DRX cycle (i.e., the UE monitors for a PDCCH addressed to a P-RNTI in the PO).

At operation 1320, the UE receives a PDCCH addressed to the P-RNTI in the monitored PO from the camped cell.

At operation 1330, the DCI in the received PDCCH addressed to the P-RNTI may schedule a plurality of downlink HARQ packets of a TB, wherein each HARQ packet is a different version (e.g., a different coding rate and/or different number of redundancy bits) of same the TB. The TB includes a paging message. The TB may be transmitted on PDSCH. In some embodiments, the DCI may indicate the number of scheduled HARQ packets and/or scheduling/resource information for HARQ packets of the TB including the paging message. In some embodiments, RRC signaling message (e.g., system information) in the cell may indicate the number of scheduled HARQ packets of the TB including the paging message. In some embodiments, the symbols/slots/subframes/frames in which the HARQ packets of the TB including the paging message are scheduled can be signaled in an RRC signaling message (e.g., system information) or the DCI. In some embodiments, the offset between slots/subframes/frames in which the HARQ packets of the TB including the paging message are scheduled by the DCI can be signaled in an RRC signaling message (e.g., system information) or the DCI in the received PDCCH addressed to the P-RNTI. In some embodiments, the offset between the end of the symbol/slot/subframe/frame in which the DCI is received and the slot/subframe/frame in which the first HARQ packet of the TB including the paging message is scheduled by the DCI can be signaled in an RRC signaling message (e.g., system information) or the DCI. In some embodiments, the PRBs and/or OFDM symbols in which the HARQ packets of the TB including the paging message are scheduled by the DCI can be signaled in an RRC signaling message (e.g., system information) or the DCI in the received PDCCH addressed to the P-RNTI. In some embodiments, the DCI may indicate a redundancy version of each HARQ packet. In some embodiments, an RRC signaling message (e.g., system information) may indicate the redundancy version of each HARQ packet. In some embodiments, the redundancy version of each HARQ packet may be pre-defined.

At operation 1340, the UE may decode the TB including the paging message by receiving and combining these HARQ packets(s). In some embodiments, the UE may receive and decode the first HARQ packet, and if decoding fails, the UE may receive the next HARQ packet, combine it with first HARQ packet and decode, if decoding fails, the may receive the next HARQ packet and combine it with previously received HARQ packets and decode and so on.

At operation 1350, the paging message in the decoded TB is then processed by the UE to determine whether there is paging for the UE.

Although FIG. 13 illustrates one example procedure 1300 for paging at a UE, various changes may be made to FIG. 13. For example, while shown as a series of operations, various operations in FIG. 13 could overlap, occur in parallel, occur in a different order, occur any number of times, be omitted, or replaced by other operations.

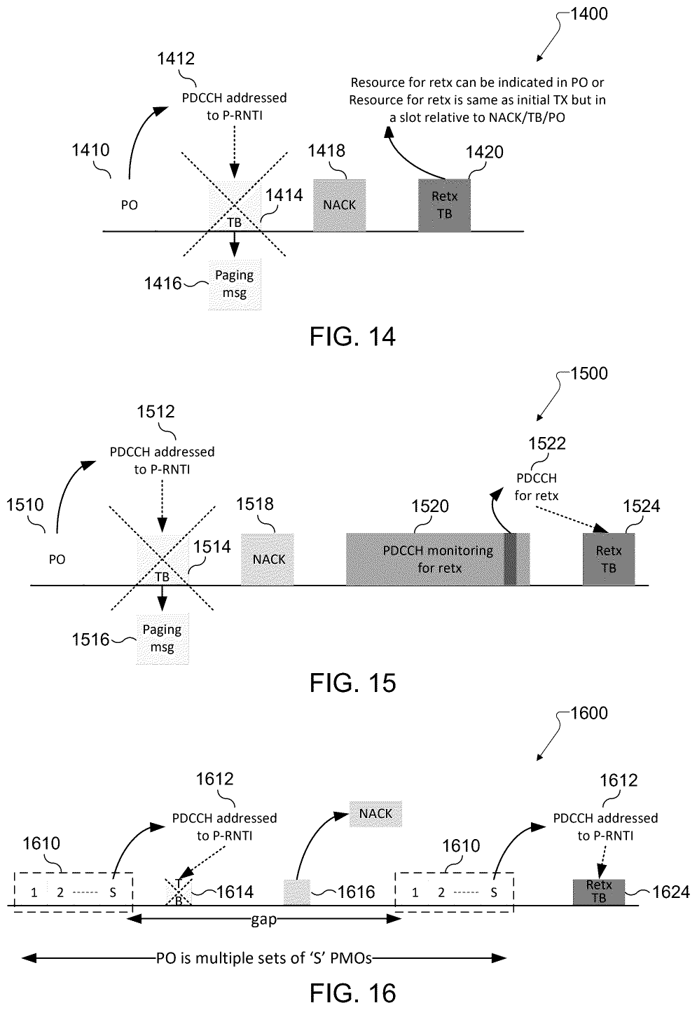

FIG. 14 illustrates an example 1400 of feedback based paging according to embodiments of the present disclosure. The embodiment of feedback based paging of FIG. 14 is for illustration only. Different embodiments of feedback based paging could be used without departing from the scope of this disclosure.

In example 1400, a UE (such as UE 116 of FIG. 1) monitors PDCCH addressed to P-RNTI 1412 in PO 1410 (or the UE monitors PDCCH addressed to P-RNTI 1412 in PDCCH monitoring occasion(s) of PO 1410).

The UE receives PDCCH addressed to P-RNTI 1412, wherein the DCI in the received PDCCH schedules DL TB 1414 for paging message 1416. The DL TB may be transmitted on a PDSCH.

The UE receives and decodes the scheduled DL TB 1414. If the UE successfully decodes the scheduled DL TB 1414 for paging, it processes the paging message 1416 and determines whether there is a paging for the UE or not. There is paging for the UE if the UE's identity is included in the paging message 1416.

If the UE fails to successfully decode the scheduled DL TB 1414 for paging, the UE transmits a negative acknowledgement (or indication to retransmit) 1418 to the network (e.g., a base station/CU/DU of the camped cell or serving cell).

In some embodiments, PO 1410 (i.e., DCI of PDCCH addressed to P-RNTI 1412) may indicate timing of the slot in which negative acknowledgement (or indication to retransmit) 1418 is transmitted by the UE. If DL TB 1414 including paging message 1416 which the UE fails to decode is scheduled in slot N, negative acknowledgement (or indication to retransmit) 1418 is transmitted in slot N+K1. K1 may be indicated in DCI of PDCCH addressed to P-RNTI 1412 by explicitly indicating the value of K1 or by indicating an entry/index of a row in a list/table signaled by system information/an RRC message where each entry/row in the list/table includes a value of K1.

In some embodiments, a PUCCH can be used for transmitting negative acknowledgement (or indication to retransmit) 1418. The PUCCH resources can be signaled in system information or an RRC message or in DCI of PDCCH addressed to P-RNTI 1412. The PUCCH resources can be signaled for one or more beams/SSBs.

In some embodiments, a dedicated RACH preamble and/or RO can be used to indicate negative acknowledgement (or indication to retransmit) 1418. The dedicated RACH preamble(s) and/or RO(s) can be signaled in system information or an RRC message or in DCI of PDCCH addressed to P-RNTI 1412. The dedicated RACH preamble(s) and/or RO(s) can be signaled for one or more beams/SSBs.

In some embodiments, the UE may transmit negative acknowledgement (or indication to retransmit) 1418 in a resource corresponding to a synchronization signal block (SSB) with a synchronization signal reference signal received power (SS-RSRP) above a threshold, or the SSB with a highest SS-RSRP.

Upon receiving the negative acknowledgement (or indication to retransmit) 1418, the network (e.g., a base station/CU/DU of camped cell or serving cell) retransmits the DL TB including the paging message (i.e., Retx TB 1420). The network may retransmit the DL TB including the paging message using a different redundancy version. The UE receives and decodes this to receive the paging message.

In some embodiments, resources/scheduling information for retransmission of DL TB 1420 can be indicated/signaled in PO 1410 (i.e., in DCI of PDCCH addressed to P-RNTI 1412 which scheduled the initial transmission of the DL TB 1414).

In some embodiments, resources (e.g., OFDM symbols, PRBs) for retransmission of DL TB 1420 are the same as the initial transmission of the DL TB 1410, but in a slot relative to the slot in which PDCCH addressed to P-RNTI 1412 is received or in a slot relative to the slot in which DL TB was scheduled (in which initial DL TB 1414 was scheduled or in which the last retransmission of DL TB 1420 was scheduled) or in a slot relative to the slot in which negative acknowledgement (or indication to retransmit) 1418 is transmitted by the UE. In some embodiments, an offset between the slot in which PDCCH addressed to P-RNTI 1412 is received and the slot for retransmission of the DL TB 1420 can be indicated/signaled in DCI of PDCCH addressed to P-RNTI 1412 or in system information or in an RRC message. In some embodiments, an offset between the slot in which DL TB was scheduled (in which initial DL TB 1414 was scheduled or in which the last retransmission of DL TB 1420 was scheduled) and the slot for retransmission of the DL TB 1420 can be indicated/signaled in DCI of PDCCH addressed to P-RNTI 1412 or in system information or in an RRC message. In some embodiments, an offset between the slot in which negative acknowledgement (or indication to retransmit) 1418 is transmitted and the slot for retransmission of the DL TB 1420 can be indicated/signaled in DCI of PDCCH addressed to P-RNTI 1412 or in system information or in an RRC message. In some embodiments, if PDCCH addressed to P-RNTI 1412 is received in slot N, retransmission of the DL TB 1420 is in slot N+P, where P can be indicated/signaled in DCI of PDCCH addressed to P-RNTI 1412 or in system information or in an RRC message. In some embodiments, if DL TB is scheduled in slot N (if initial DL TB 1414 is scheduled in slot N or if the last retransmission of DL TB 1420 is scheduled in slot N), retransmission of the DL TB is in slot N+P, where P can be indicated/signaled in DCI of PDCCH addressed to P-RNTI 1412 or in system information or in an RRC message. In some embodiments, if negative acknowledgement (or indication to retransmit) 1418 is transmitted by the UE in slot N, retransmission of the DL TB 1420 is in slot N+P, where P can be indicated/signaled in DCI of PDCCH addressed to P-RNTI 1412 or in system information or in an RRC message.

In some embodiments, a total number of retransmissions (or a total number of transmissions including initial and retransmissions) of the DL TB including the paging message can be indicated in DCI of PDCCH addressed to P-RNTI 1412 or in system information or in an RRC message.

In some embodiments, if negative acknowledgement (or indication to retransmit) 1418 is received by the network and the network has received a response to paging from all UEs which were paged in paging message 1416, the network does not retransmit the DL TB 1420 including the paging message. This is because the same PO can be monitored by several UEs, and only a subset of these UEs may be paged in a PO. In this case, if the NACK 1418 is from a UE monitoring the PO but not paged in paging message 1416, the network can ignore NACK 1418 if a paging response is received from all UEs which are paged.

In some embodiments, the retransmission(s) in FIG. 14 are transmitted within a DRX cycle (or a DRX cycle of the UE).

Although FIG. 14 illustrates one example 1400 of feedback based paging, various changes may be made to FIG. 14. For example, various changes to the number of NACKs 1418, the number of Retx TBs 1420, etc. could be made according to particular needs.

FIG. 15 illustrates another example 1500 of feedback based paging according to embodiments of the present disclosure. The embodiment of feedback based paging of FIG. 15 is for illustration only. Different embodiments of feedback based paging could be used without departing from the scope of this disclosure.

In example 1500, a UE (such as UE 116 of FIG. 1) monitors PDCCH addressed to P-RNTI 1512 in PO 1510 (or the UE monitors PDCCH addressed to P-RNTI 1512 in PDCCH monitoring occasion(s) of PO 1510).

The UE receives PDCCH addressed to P-RNTI 1512, wherein the DCI in the received PDCCH schedules DL TB 1514 for paging message 1516. The DL TB may be transmitted on a PDSCH.

The UE receives and decodes the scheduled DL TB 1514. If the UE successfully decodes the scheduled DL TB 1514 for paging, it processes the paging message 1516 and determines whether there is a paging for the UE or not. There is paging for the UE if the UE's identity is included in the paging message 1516.

If the UE fails to successfully decode the scheduled DL TB 1514 for paging, the UE transmits a negative acknowledgement (or indication to retransmit) 1518 to the network (e.g., a base station/CU/DU of the camped cell or serving cell).

In some embodiments, PO 1510 (i.e., DCI of PDCCH addressed to P-RNTI 1512) may indicate timing of the slot in which negative acknowledgement (or indication to retransmit) 1518 is transmitted by the UE. If DL TB 1514 including paging message 1516 which the UE fails to decode is scheduled in slot N, negative acknowledgement (or indication to retransmit) 1518 is transmitted in slot N+K1. K1 may be indicated in DCI of PDCCH addressed to P-RNTI 1512 by explicitly indicating the value of K1 or by indicating an entry/index of row in a list/table signaled by system information/an RRC message where each entry/row in the list/table includes a value of K1.

In some embodiments, a PUCCH can be used for transmitting negative acknowledgement (or indication to retransmit) 1518. The PUCCH resources can be signaled in system information or an RRC message or in DCI of PDCCH addressed to P-RNTI 1512. The PUCCH resources can be signaled for one or more beams/SSBs.

In some embodiments, a dedicated RACH preamble and/or RO can be used to indicate negative acknowledgement (or indication to retransmit) 1518. The dedicated RACH preamble(s) and/or RO(s) can be signaled in system information or an RRC message or in DCI of PDCCH addressed to P-RNTI 1512. The dedicated RACH preamble(s) and/or RO(s) can be signaled for one or more beams/SSBs.

In some embodiments, the UE may transmit negative acknowledgement (or indication to retransmit) 1518 in a resource corresponding to an SSB with an SS-RSRP above a threshold, or the SSB with a highest SS-RSRP.

Upon transmitting the negative acknowledgement (or indication to retransmit) 1518, the UE monitors PDCCH monitoring occasion(s) for paging (or for paging retransmission) in a window 1520 to receive PDCCH 1522 scheduling the retransmission of DL TB 1524 including the paging message. The window size can be fixed or configurable (via DCI/SI/an RRC message etc.). The start of window 1520 can be fixed or configurable (via DCI/SI/an RRC message etc.). The window 1520 may start an offset from the end of the symbol/slot in which negative acknowledgement (or indication to retransmit) 1518 is transmitted. PDCCH 1522 scheduling the retransmission can be addressed to the P-RNTI or another RNTI different from the P-RNTI.

Upon receiving the negative acknowledgement (or indication to retransmit) 1518, the network (e.g., base station/CU/DU of camped cell or serving cell) transmits DCI (i.e., PDCCH for retx 1522) scheduling retransmission of DL TB 1524 including the paging message and retransmits the DL TB in resources indicated by the DCI. The network may retransmit the DL TB using a different redundancy version. The UE receives and decodes the retransmission of DL TB 1524 to receive the paging message.

In some embodiments, if negative acknowledgement (or indication to retransmit) 1518 is received by the network and the network has received a response to paging from all UEs which were paged in the paging message, the network does not retransmit the DL TB 1524 including the paging message. This is because the same PO can be monitored by several UEs, and only a subset of these UEs may be paged in the PO. In this case, if NACK 1518 is from a UE monitoring the PO but not paged in paging message, the network can ignore NACK 1518 if a paging response is received from all the UEs which are paged.

In some embodiments, the retransmission(s) in FIG. 15 are transmitted within a DRX cycle (or a DRX cycle of the UE).

Although FIG. 15 illustrates one example 1500 of feedback based paging, various changes may be made to FIG. 15. For example, various changes to the number of NACKs 1518, the number of Retx TBs 1524, etc. could be made according to particular needs.

FIG. 16 illustrates another example 1600 of feedback based paging according to embodiments of the present disclosure. The embodiment of feedback based paging of FIG. 16 is for illustration only. Different embodiments of feedback based paging could be used without departing from the scope of this disclosure.

In example 1600, a UE (such as UE 116 of FIG. 1) monitors PDCCH addressed to P-RNTI 1612 in PO 1610 (or the UE monitors PDCCH addressed to P-RNTI 1612 in PDCCH monitoring occasion(s) of PO 1610). PO 1610 includes multiple sets of ‘S’ consecutive PDCCH monitoring occasion(s) for paging, with a gap between sets. The gap may be signaled (e.g., by an offset, or PDCCH monitoring occasion #). The gap is large enough to receive TB 1614, and transmit/receive/process negative ack 1616. S is the number of transmitted SSBs in the cell. The number of sets in PO 1610 can be signaled by the network (e.g., in SI or an RRC message) or can be pre-defined.

The UE monitors the PDCCH addressed to P-RNTI 1612 in the first set of PDCCH monitoring occasion(s) for paging in PO 16100.

The UE receives PDCCH addressed to P-RNTI 1612, wherein the DCI in the received PDCCH schedules a DL TB 1614 for a paging message. DL TB 1614 may be transmitted on a PDSCH.

The UE receives and decodes the scheduled DL TB 1614.

If the UE successfully decodes the scheduled DL TB 1614 for paging, the UE processes the paging message and determines whether there is paging for the UE or not. There is paging for the UE if the UE's identity is included in the paging message.

If the UE fails to successfully decode the scheduled DL TB 1614, the UE transmits a negative acknowledgement (or indication to retransmit) 1616 to the network (e.g., base station/CU/DU of camped cell or serving cell).

In some embodiments, PO 1610 (i.e., DCI of PDCCH addressed to P-RNTI 1612) may indicate timing of the slot in which negative acknowledgement (or indication to retransmit) 1616 is transmitted by the UE. If DL TB 1614 including a paging message which the UE fails to decode is scheduled in slot N, negative acknowledgement (or indication to retransmit) 1616 is transmitted in slot N+K1. K1 may be indicated in DCI of PDCCH addressed to P-RNTI 1612 by explicitly indicating the value of K1 or by indicating an entry/index of row in a list/table signaled by system information/an RRC message where each entry/row in the list/table includes a value of K1.

In some embodiments, a PUCCH can be used for transmitting negative acknowledgement (or indication to retransmit) 1616. The PUCCH resources can be signaled in system information or an RRC message or in DCI of PDCCH addressed to P-RNTI 1612.

In some embodiments, a dedicated RACH preamble and/or RO can be used to indicate negative acknowledgement (or indication to retransmit) 1616. The dedicated RACH preamble(s) and/or RO(s) can be signaled in system information or an RRC message or in DCI of PDCCH addressed to P-RNTI 1612.

In some embodiments, the UE may transmit negative acknowledgement (or indication to retransmit) 1616 in a resource corresponding to an SSB with an SS-RSRP above a threshold, or the SSB with a highest SS-RSRP.

Upon transmitting the negative acknowledgement (or indication to retransmit) 1616, the UE monitors PDCCH addressed to P-RNTI 1612 in the next set of PDCCH monitoring occasion(s) for paging in PO 1610, if available.

The UE receives PDCCH addressed to P-RNTI 1612, wherein the DCI in the received PDCCH schedules a DL TB for paging message (i.e., Retx TB 1624). DL TB 1624 may be transmitted on a PDSCH.

The UE receives and decodes the scheduled DL TB 1624.

If the UE successfully decodes the scheduled DL TB for paging, the UE processes the paging message and determine whether there is paging for the UE or not. Paging is there if UE's identity is included in the paging message.

If the UE fails to successfully decode the scheduled DL TB 1624, the UE transmits a negative acknowledgement (or indication to retransmit) (not shown) to the network (e.g., a base station/CU/DU of camped cell or serving cell). Upon transmitting the negative acknowledgement (or indication to retransmit), the UE monitors PDCCH addressed to P-RNTI in the next set of PDCCH monitoring occasion(s) for paging in PO, if available. If not available, the UE will monitor a PO in next DRX cycle (not shown).

Upon receiving the negative acknowledgement (or indication to retransmit) 1616, the network (e.g., a base station/CU/DU of camped cell or serving cell) transmits DCI scheduling retransmission of DL TB including paging message in next set of PMOs of PO and retransmits DL TB 1624 in resources indicated by the DCI. The network may retransmit TB 1624 using a different redundancy version. The UE receives and decodes this TB 1624 to receive the paging message.

In some embodiments, if negative acknowledgement (or indication to retransmit) 1616 is received by the network and the network has received a response to paging from all UEs which were paged in the paging message, the network does not retransmit the DL TB including the paging message. This is because the same PO can be monitored by several UEs, and only a subset of these UEs may be paged in the PO. In this case, if NACK 1616 is from a UE monitoring the PO but not paged in the paging message, the network can ignore NACK 1616 if a paging response is received from all UEs which are paged.

In some embodiments, the retransmission(s) in FIG. 16 are transmitted within a DRX cycle (or a DRX cycle of the UE).

Although FIG. 16 illustrates one example 1600 of feedback based paging, various changes may be made to FIG. 16. For example, various changes to the number of NACKs 1616, the number of Retx TBs 1624, etc. could be made according to particular needs.

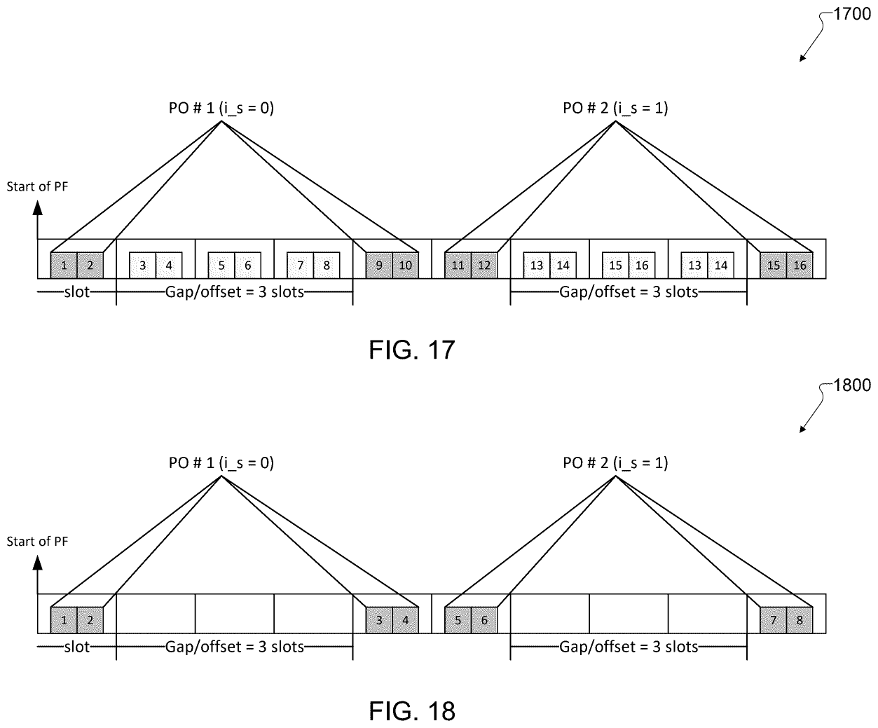

FIG. 17 illustrates an example 1700 of PMOs to PO mapping according to embodiments of the present disclosure. The embodiment of PMOs to PO mapping of FIG. 17 is for illustration only. Different embodiments of PMOs to PO mapping could be used without departing from the scope of this disclosure.

In FIG. 17, example 1700 illustrates an example of PMOs to PO mapping according to the operations described regarding example 1600 of FIG. 16. In example 1700, from the start of the PF, PDCCH monitoring occasions for paging are sequentially numbered. Each PO has two sets of ‘S’ PDCCH monitoring occasions for paging where S is 2. The Gap/offset between the two sets is 3 slots. There are two POs per PF. The first PO (i_s=0) includes two sets of PMOs, the first set with PMO 1 and 2 and the second set with PMO 9 and 10. The second PO (i_s=1) includes two sets of PMOs, the first set with PMO 11 and 12 and the second set with PMO 15 and 16.

Although FIG. 17 illustrates one example 1700 of PMOs to PO mapping, various changes may be made to FIG. 17. For example, various changes to the number of slots per PO, the gap/offset size, etc. could be made according to particular needs.

FIG. 18 illustrates another example 1800 of PMOs to PO mapping according to embodiments of the present disclosure. The embodiment of PMOs to PO mapping of FIG. 18 is for illustration only. Different embodiments of PMOs to PO mapping could be used without departing from the scope of this disclosure.

In FIG. 18, example 1800 illustrates another example of PMOs to PO mapping according to the operations described regarding example 1600 of FIG. 16. In example 1800, from the start of the PF, PDCCH monitoring occasions for paging are sequentially numbered except for PDCCH monitoring occasions for paging in the slots corresponding to the gap/offset. Each PO has two sets of ‘S’ PDCCH monitoring occasions for paging, where S is 2. The Gap/offset between the two sets is 3 slots. There are two POs per PF. The first PO (i_s=0) includes two sets of PMOs, the first set with PMO 1 and 2 and the second set with PMO 3 and 4. The Second PO (i_s=1) includes two sets of PMOs, the first set with PMO 5 and 6 and the second set with PMO 11 and 12.

Although FIG. 18 illustrates one example 1800 of PMOs to PO mapping, various changes may be made to FIG. 18. For example, various changes to the number of slots per PO, the gap/offset size, etc. could be made according to particular needs.

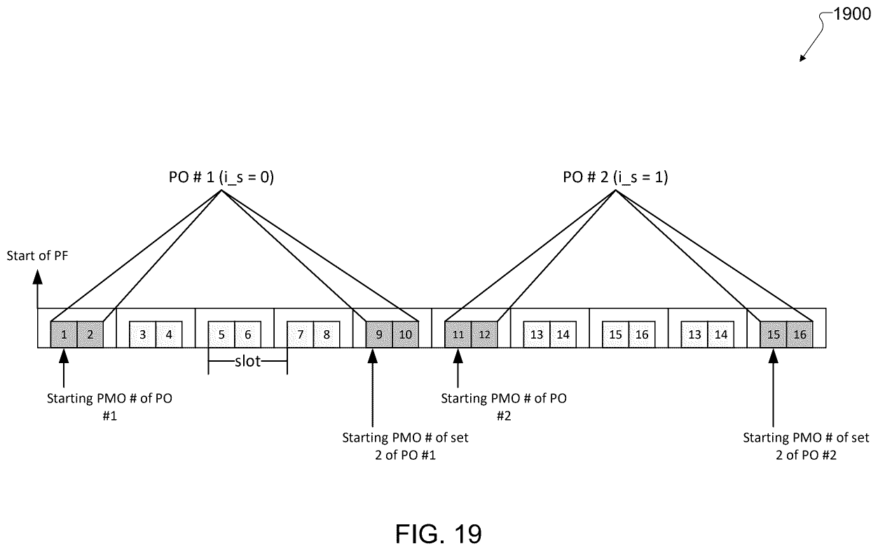

FIG. 19 illustrates another example 1900 of PMOs to PO mapping according to embodiments of the present disclosure. The embodiment of PMOs to PO mapping of FIG. 19 is for illustration only. Different embodiments of PMOs to PO mapping could be used without departing from the scope of this disclosure.

In FIG. 19, example 1900 illustrates another example of PMOs to PO mapping according to the operations described regarding example 1600 of FIG. 16. The starting PDCCH monitoring occasion number for each set of S consecutive PDCCH monitoring occasion(s) in the PO can be signaled by the network. For example, consider that S is 2 and the number of sets is 2. There are two POs per PF.

For PO #1: the starting PDCCH monitoring occasion number is 1 for set 1 and 9 for set 2. The PO includes two sets, where set 1 includes PDCCH monitoring occasions 1 to 2 and set 2 consists of PDCCH monitoring occasions 9 to 10.

For PO #2: the starting PDCCH monitoring occasion number is 11 for set 1 and 15 for set 2. The PO includes two sets, where set 1 includes PDCCH monitoring occasions 11 to 12 and set 2 consists of PDCCH monitoring occasions 15 to 16.

In some embodiments, for the operations described regarding FIG. 6 to FIG. 9, S can be ‘S*X’ where X is number of PMOs per SSB.

Although FIG. 19 illustrates one example 1900 of PMOs to PO mapping, various changes may be made to FIG. 18. For example, various changes to the number of slots per PO, the gap/offset size, etc. could be made according to particular needs.

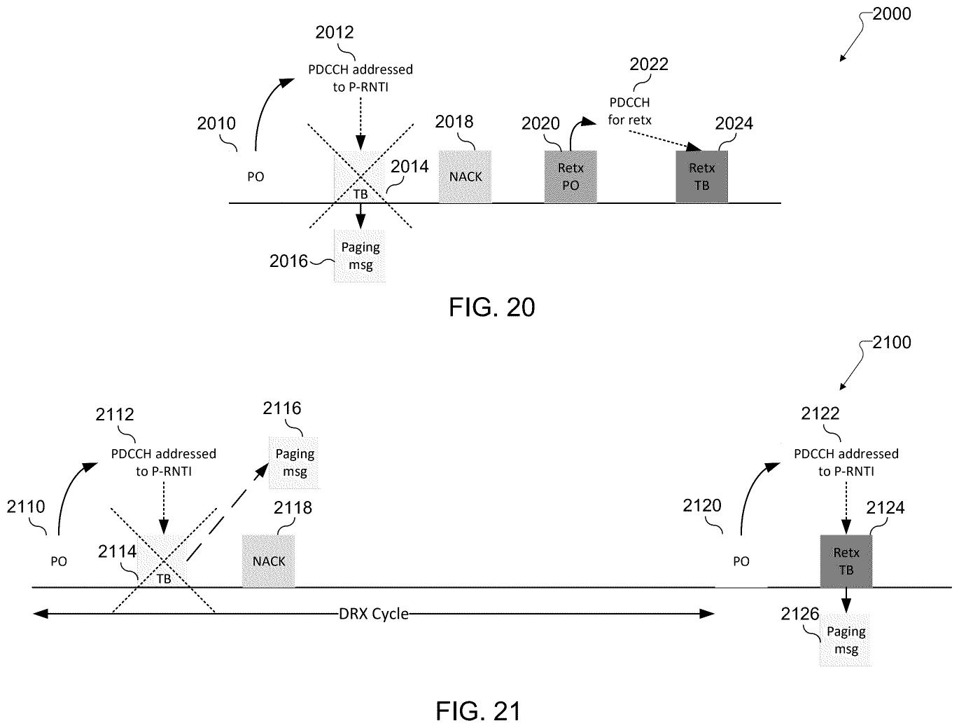

FIG. 20 illustrates another example 2000 of feedback based paging according to embodiments of the present disclosure. The embodiment of feedback based paging of FIG. 20 is for illustration only. Different embodiments of feedback based paging could be used without departing from the scope of this disclosure.

In example 2000, a UE (such as UE 116 of FIG. 1) determines its PO (i.e., PO 2010) wherein the UE's PO is identified by a PO index (i_s). i_s can be determined by the UE as described earlier herein. PMOs of PO 2010 or PO 2010 corresponding to PO index i_s can be determined by the UE as described earlier herein.

The UE monitors PDCCH addressed to P-RNTI 2012 in the determined PO 2010 (or the UE monitors PDCCH addressed to P-RNTI 2012 in PDCCH monitoring occasion(s) of PO 2010). PO 2010 includes ‘S*X’ PDCCH monitoring occasions.

The UE receives PDCCH addressed to P-RNTI 2012, wherein the DCI in the received PDCCH schedules a DL TB 2014 for paging message 2016. DL TB 2014 may be transmitted on a PDSCH.

The UE receives and decodes the scheduled DL TB 2014.

If the UE successfully decodes the scheduled DL TB 2014 for paging, it processes the paging message 2016 and determines whether there is paging for the UE or not. There is paging for the UE if the UE's identity is included in the paging message 2016.

If the UE fails to successfully decode the scheduled DL TB 2014, the UE transmits a negative acknowledgement (or indication to retransmit) 2018 to the network (e.g., a base station/CU/DU of camped cell or serving cell).

In some embodiments, PO 2010 (i.e., DCI of PDCCH addressed to P-RNTI 2012) may indicate timing of the slot in which negative acknowledgement (or indication to retransmit) 2018 is transmitted by the UE. If DL TB 2014 including paging message 2016 is scheduled in slot N, negative acknowledgement (or indication to retransmit) 2018 is transmitted in slot N+K1. K1 may be indicated in DCI of PDCCH addressed to P-RNTI 2012 by explicitly indicating the value of K1 or by indicating an entry in a list/table signaled by system information/an RRC message, where each entry includes a value of K1.

In some embodiments, PUCCH can be used for transmitting negative acknowledgement (or indication to retransmit) 2018. The PUCCH resources can be signaled in system information or an RRC message or in DCI of PDCCH addressed to P-RNTI 2012.

In some embodiments, a dedicated RACH preamble and/or RO can be used to indicate negative acknowledgement (or indication to retransmit) 2018. The dedicated RACH preamble(s) and/or RO(s) can be signaled in system information or an RRC message or in DCI of PDCCH addressed to P-RNTI 2012.

In some embodiments, the UE may transmit negative acknowledgement (or indication to retransmit) 2018 in a resource corresponding to an SSB with an SS-RSRP above a threshold or the SSB with the highest SS-RSRP.

In some embodiments, upon transmitting the negative acknowledgement (or indication to retransmit) 2018, the UE determines the PO index (i_s) for retransmission. The UE identifies the PO 2020 based on the PO index for retransmission. PMOs of PO 2020 or PO 2020 corresponding to i_s can be determined by the UE as explained earlier herein.

The i_s for retransmission can be at an offset for the i_s for the initial transmission. The offset can be signaled by network in system information or an RRC message or in DCI of PDCCH addressed to P-RNTI 2012.

The i_s for retransmission can be signaled by the network in system information or an RRC message or DCI of PDCCH addressed to P-RNTI 2012.

The i_s for retransmission can be the i_s for initial transmission+Ns or the i_s for retransmission can be the i_s last monitored by the UE+Ns. Ns is the number of POs per PF (or number of POs per PF of the initial transmission).

Alternately, in some embodiments, upon transmitting the negative acknowledgement (or indication to retransmit) 2018, the UE determines the PO for retransmission 2020 based on a starting PDCCH monitoring occasion # for retransmission PO 2020. PO for retransmission 2020 includes ‘S*X’ PDCCH monitoring occasions starting from the starting PDCCH monitoring occasion # for retransmission PO 2020. The starting PDCCH monitoring occasion # for retransmission PO 2020 can be signaled by the network in system information or an RRC message or in DCI of PDCCH addressed to P-RNTI 2012. The starting PDCCH monitoring occasion # for retransmission PO 2020 can be signaled by the network in system information or an RRC message for each PO index. In case there are multiple retransmissions, the starting PDCCH monitoring occasion # for retransmission PO 2020 for each retransmission can be signaled by the network.

The UE monitors PDCCH addressed to P-RNTI 2022 in the determined PO 2020 (or the UE the monitors PDCCH addressed to P-RNTI in PDCCH monitoring occasion(s) of PO 2020) for retransmission. PO 2020 includes ‘S*X’ PDCCH monitoring occasions. The UE receives PDCCH addressed to P-RNTI 2022, wherein the DCI in the received PDCCH schedules a DL TB 2024 for the paging message. DL TB 2024 may be transmitted on a PDSCH. The UE receives and decodes the scheduled DL TB 2024. If the UE successfully decodes the scheduled DL TB 2024 for paging, the UE processes the paging message and determines whether there is paging for the UE or not. There is paging for the UE if UE's identity is included in the paging message.

Upon receiving the negative acknowledgement (or indication to retransmit) 2018, the network (e.g., a base station/CU/DU of camped cell or serving cell) transmits DCI scheduling retransmission of DL TB 2024 including the paging message in the PO for retransmission 2020 and retransmits DL TB 2024 in resources indicated by the DCI. The network may retransmit DL TB 2024 using a different redundancy version. PO for retransmission 2020 can be determined by the network in the same manner as determined by the UE.

In some embodiments, if negative acknowledgement (or indication to retransmit) 2018 is received by the network and the network has received a response to paging from all UEs which were paged in paging message 2016, the network does not retransmit the DL TB 202 including the paging message. This is because the same PO can be monitored by several UEs and only subset of these UEs may be paged in PO 2010. In this case, if NACK 2018 is from a UE monitoring the PO 2010 but not paged in paging message 2016, the network can ignore NACK 2018 if a paging response is received from all UEs which are paged.

In some embodiments, the retransmission(s) in FIG. 10 are transmitted within a DRX cycle (or DRX cycle of a UE).

Although FIG. 20 illustrates one example 2000 of feedback based paging, various changes may be made to FIG. 20. For example, various changes to the number of NACKs 2018, the number of Retx TBs 2024, etc. could be made according to particular needs.

FIG. 21 illustrates another example 2100 of feedback based paging according to embodiments of the present disclosure. The embodiment of feedback based paging of FIG. 21 is for illustration only. Different embodiments of feedback based paging could be used without departing from the scope of this disclosure.

In example 2100, a UE (such as UE 116 of FIG. 1) monitors a PO 2110 in a DRX cycle. The UE monitors PDCCH addressed to P-RNTI 2112 in PO 2110 (or the UE monitors PDCCH addressed to P-RNTI 2112 in PDCCH monitoring occasion(s) of PO 2110).

The UE receives PDCCH addressed to P-RNTI 2112, wherein the DCI in the received PDCCH schedules DL TB 2114 for paging message 2116. DL TB 2114 may be transmitted on a PDSCH.

The UE receives and decodes the scheduled DL TB 2114.

If the UE successfully decodes the scheduled DL TB 2114 for paging, the UE processes the paging message 2116 and determines whether there is paging for the UE or not. There is paging for the UE if the UE's identity is included in the paging message 2116.

If the UE fails to successfully decode the scheduled DL TB 2114 for paging, the UE transmits a negative acknowledgement (or indication to retransmit) 2118 to the network (e.g., a base station/CU/DU of the camped cell or serving cell).

In some embodiments, PO 2110 (i.e., DCI of PDCCH addressed to P-RNTI 2112) may indicate timing of the slot in which negative acknowledgement (or indication to retransmit) 2118 is transmitted by the UE. If DL TB 2114 including paging message 2116, which the UE fails to decode is scheduled in slot N, negative acknowledgement (or indication to retransmit) 2118 is transmitted in slot N+K1. K1 may be indicated in DCI of PDCCH addressed to P-RNTI 2112 by explicitly indicating the value of K1 or by indicating an entry/index of a row in a list/table signaled by system information/an RRC message where each entry/row in the list/table includes a value of K1.

In some embodiments, a PUCCH can be used for transmitting negative acknowledgement (or indication to retransmit) 2118. The PUCCH resources can be signaled in system information or an RRC message or in DCI of PDCCH addressed to P-RNTI 2112. The PUCCH resources can be signaled for one or more beams/SSBs.

In some embodiments, a dedicated RACH preamble and/or RO can be used to indicate negative acknowledgement (or indication to retransmit) 2118. The dedicated RACH preamble(s) and/or RO(s) can be signaled in system information or RRC message or in DCI of PDCCH addressed to P-RNTI. The dedicated RACH preamble(s) and/or RO(s) can be signaled for one or more beams/SSBs.

In some embodiments, the UE may transmit negative acknowledgement (or indication to retransmit) 2118 in a resource corresponding to an SSB with an SS-RSRP above a threshold or the SSB with a highest SS-RSRP.

In some embodiments, upon receiving the negative acknowledgement (or indication to retransmit) 2118, the network transmits PDCCH addressed to P-RNTI 2122 in PO 2120 in the next DRX cycle, wherein the DCI in the PDCCH schedules a retransmission of DL TB 2124 including paging message 2126 (e.g., HARQ retransmission). The Network may perform retransmission of DL TB 2124 including paging message 2126 (e.g., HARQ retransmission) using a different redundancy version.

The UE receives PDCCH addressed to P-RNTI 2122 in PO 2120 in the next DRX cycle. The DCI in the PDCCH schedules a retransmission of DL TB 2124 including paging message 2126 (e.g., HARQ retransmission). The UE may combine the scheduled DL TB 2124 in next DRX cycle with scheduled DL TB 2114 in the current DRX cycle to decode the DL TB 2124 including paging message 2126.

Alternately, in some embodiments, if negative acknowledgement (or indication to retransmit) 2118 is received by the network and the network has not received a response to paging from all UEs which were paged in paging message) before the PO 2120 in next DRX cycle, the network transmits PDCCH addressed to P-RNTI 2122 in PO 2120 in the next DRX cycle, wherein the DCI in the PDCCH schedules a retransmission of DL TB 2124 including paging message 2126 (e.g., HARQ retransmission). The network may perform retransmission of DL TB 2124 including paging message 2126 (e.g., HARQ retransmission) using a different redundancy version.

The UE receives PDCCH addressed to P-RNTI 2122 in PO 2120 in the next DRX cycle. The DCI in the PDCCH schedules a retransmission of DL TB 2124 including paging message 2126 (e.g., HARQ retransmission). The UE may combine the scheduled DL TB 2124 in the next DRX cycle with scheduled DL TB 2114 in the current DRX cycle to decode the DL TB 2124 including paging message 2126.

Although FIG. 21 illustrates one example 2100 of feedback based paging, various changes may be made to FIG. 21. For example, various changes to the number of NACKs 2118, the number of Retx TBs 2124, etc. could be made according to particular needs.

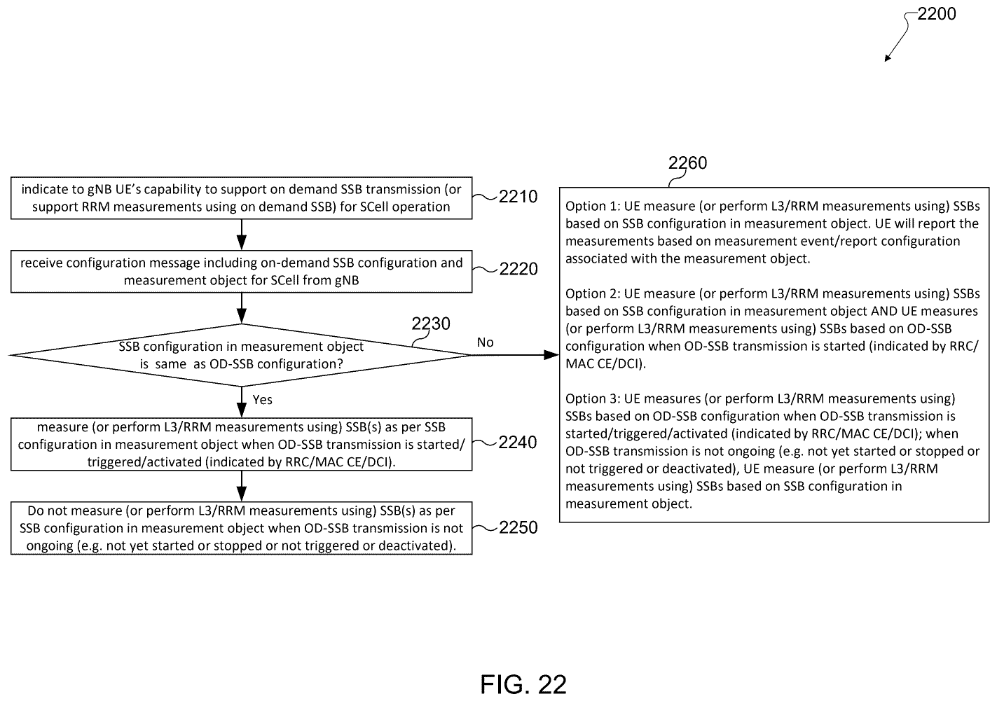

FIG. 22 illustrates an example procedure 2200 for operating a UE according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method for operating a UE could be used without departing from the scope of this disclosure.

In the example of FIG. 22, procedure 2200 begins at operation 2210. At operation 2210, in some embodiments, a UE (such as UE 116 of FIG. 1) may indicate the UE's capability to support on demand SSB transmission for SCell operation. This capability can be per UE capability or this capability can be per frequency capability or this capability can be per frequency band capability or this capability can be per frequency range (FR1, FR2-1, FR2-2, FR3, etc.) capability. In some embodiments, the UE may indicate the UE's capability to support RRM measurements using on demand SSB transmission for SCell operation. This capability can be per UE capability or this capability can be per frequency capability or this capability can be per frequency band capability or this capability can be per frequency range (FR1, FR2-1, FR2-2, FR3, etc.) capability.

At operation 2220, a gNB (such as gNB 102 of FIG. 1) sends an RRCReconfiguration message to the UE, wherein the message includes configuration of one or more SCells.

In some embodiments, the RRCReconfiguration message may indicate whether the gNB supports on demand SSB transmission for configured SCell(s). This indication can be common for all configured SCells or this indication can be per configured SCell. The gNB may indicate support of on demand SSB transmission for zero, one or more configured SCells. In some embodiments, this indication can be implicit (i.e., the presence of an OD-SSB configuration indicates support of on demand SSB transmission).

In some embodiments, for a configured SCell for which the gNB supports on demand SSB (OD-SSB) transmission, the gNB may provide/signal (e.g., in the RRCReconfiguration message) the OD-SSB configuration (e.g., SSB frequency, SSB periodicity, transmitted SSBs, SSB SCS, etc.) indicating time and frequency location(s) of on demand SSB transmission. This configuration can be per BWP of a configured SCell or can be common for all BWPs of a configured SCell. In some embodiments, a nonCellDefiningSSB IE may be configured in the DL BWP configuration and the network may indicate whether the on-demand SSB configuration is the same as the SSB configuration in nonCellDefiningSSB (or in other words network indicate whether on demand SSB configuration for the DL BWP is the SSB configuration included in nonCellDefiningSSB). Alternately, if on-demand SSB configuration is not signaled in the DL BWP and nonCellDefiningSSB is configured, the UE may apply nonCellDefiningSSB configuration as the on-demand SSB configuration if the SCell supports on-demand SSB.

In some embodiments, for a configured SCell, the gNB may indicate/signal a measurement object for measurements (for L3 measurements/RRM measurements). For indicating/signaling a measurement object of an SCell, a list of measurement objects (each identified by MeasObjectId) may be signaled in the RRCReconfiguration message and configuration (e.g., in Serving Cell configuration [ServingCellConfig IE] of the SCell or in the DL BWP configuration of the SCell, the DL BWP configuration is for each DL BWP configured for the SCell) of the SCell includes MeasObjectId of a measurement object in the list. The measurement object of the SCell is the measurement object indicated by MeasObjectId. The measurement object includes the SSB configuration of the SCell, wherein the configuration includes one or more of SSB Frequency, SSB Subcarrier Spacing, smtc or SSB periodicity, ssb-ToMeasure (or transmitted SSB[s]) etc. If the MeasObjectId is present in a downlink BWP and the BWP is activated, the UE uses the measurement object indicated by this for the serving cell measurements. Otherwise, the UE uses the measurement object indicated by MeasObjectId in the Serving Cell configuration. MeasObjectId can be separately signaled for OD-SSB and periodic SSB transmission. For example, onDemandSSBservingCellMO and servingCellMO fields can indicate MeasObjectId for OD-SSB and periodic SSB transmission respectively. onDemandSSBservingCellMO and servingCellMO can be signaled in the Serving Cell configuration (ServingCellConfig IE) of the SCell or in the DL BWP configuration of the SCell. The DL BWP configuration is for each DL BWP configured for the SCell.

In some embodiments, for the measurement object indicated by onDemandSSBservingCellMO, the following relationship applies between this measurement object and nonCellDefiningSSB in BWP-DownlinkDedicated of the associated downlink BWP: if ssbFrequency is configured, the value of ssbFrequency is the same as the absoluteFrequencySSB in the nonCellDefiningSSB.

In some embodiments, for the measurement object indicated by onDemandSSBservingCellMO, the following relationship applies between this measurement object and On demand SSB configuration in BWP-DownlinkDedicated of the associated downlink BWP: if ssbFrequency is configured, the value of ssbFrequency is the same as the absoluteFrequencySSB in the On demand SSB configuration.

At operation 2230, in some embodiments, the UE determines whether the SSB configuration in the measurement object is the same as the OD-SSB configuration. If OD-SSB is configured (e.g., the OD-SSB configuration is received from the gNB) and if the SSB configuration in the measurement object is the same as the OD-SSB configuration (or if the SSB configuration in the measurement object is for the OD-SSB or if the measurement object includes the OD-SSB configuration or if the measurement object is for OD-SSB), procedure 2200 proceeds to operation 2240. Otherwise, If the OD-SSB is configured (e.g., the OD-SSB configuration is received from the gNB) and if the SSB configuration in the measurement object is not the same as the OD-SSB configuration (or if the SSB configuration in the measurement object is not for the OD-SSB or if the measurement object does not include the OD-SSB configuration or if the measurement object is for always ON periodic SSBs), procedure 2200 proceeds to operation 2260.

At operation 2240, the UE measures (or performs L3/RRM measurements using) SSB(s) as per the SSB configuration in the measurement object when OD-SSB transmission is started/triggered/activated (indicated by RRC/MAC CE/DCI). The UE will report the measurements based on the measurement event/report configuration associated with the measurement object. The measurement event/report configuration associated with measurement object is signaled by the gNB.

At operation 2250, the UE does not measure (or perform L3/RRM measurements using) SSB(s) as per the SSB configuration in the measurement object when OD-SSB transmission is not ongoing (e.g., not yet started or stopped or not triggered or deactivated).

At operation 2260, the UE assumes that the SSB configuration in the measurement object is for always ON periodic SSBs. In some embodiments (“option 1”), the UE measures (or perform L3/RRM measurements using) SSBs based on the SSB configuration in the measurement object. In these embodiments, the UE will report the measurements based on the measurement event/report configuration associated with the measurement object. Alternately, in some embodiments, (“option 2”), the UE measures (or performs L3/RRM measurements using) SSBs based on the SSB configuration in the measurement object and the UE measures (or performs L3/RRM measurements using) SSBs based on the OD-SSB configuration when the OD-SSB transmission is started (indicated by RRC/MAC CE/DCI). In these embodiments, the UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures only SSBs based on the SSB configuration in the measurement object and the case when the UE additionally measures SSBs based on the OD-SSB configuration when the OD-SSB transmission is started. Alternately, in some embodiments (“option 3”), the UE measures (or performs L3/RRM measurements using) SSBs based on the OD-SSB configuration when the OD-SSB transmission is started/triggered/activated (indicated by RRC/MAC CE/DCI). In these embodiments, when the OD-SSB transmission is not ongoing (e.g., not yet started or stopped or not triggered or deactivated), the UE measures (or performs L3/RRM measurements using) SSBs based on the SSB configuration in the measurement object. The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures SSBs based on the SSB configuration in the measurement object and the case when the UE measures SSBs based on the OD-SSB configuration when the OD-SSB transmission is started.

In some embodiments, the gNB can indicate (via RRC or MAC CE or DCI) to the UE whether to perform option 1 or option 2 or option 3.

Alternately, at operation 2230, in some embodiments, for an SCell, if OD-SSB is configured (e.g., an OD-SSB configuration is received from the gNB) and if the SSB configuration in the measurement object is the same as the OD-SSB configuration (or if the SSB configuration in the measurement object is for OD-SSB or if the measurement object includes an OD-SSB configuration or if the measurement object is for OD-SSB), if an indication (“indication A”) to measure (or perform L3/RRM measurements using) OD-SSB(s) is received from the gNB, the UE measures (or performs L3/RRM measurements using) the SSB(s) as per the SSB configuration in the measurement object when OD-SSB transmission is started/triggered/activated (indicated by RRC/MAC CE/DCI). If the indication is not received, the UE does not measure (or perform L3/RRM measurements using) SSB(s) as per the SSB configuration in measurement object.

Alternately, at operation 2230, in some embodiments, for an SCell, if OD-SSB is configured (e.g., an OD-SSB configuration is received from the gNB) and if the SSB configuration in the measurement object is not the same as the OD-SSB configuration (or if the SSB configuration in the measurement object is not for OD-SSB or if the measurement object does not include an OD-SSB configuration or if the measurement object is for always ON periodic SSBs), the UE assumes that the SSB configuration in the measurement object is for always ON periodic SSBs. If an indication (“indication B”) to measure (or perform L3/RRM measurements using) both OD-SSBs and always ON periodic SSBs is received, the UE measures (or performs L3/RRM measurements using) SSBs based on the SSB configuration in the measurement object and the UE measures (or performs L3/RRM measurements using) SSBs based on the OD-SSB configuration when the OD-SSB transmission is started (indicated by RRC/MAC CE/DCI). The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures only SSBs based on the SSB configuration in the measurement object and the case when the UE additionally measures SSBs based on the OD-SSB configuration when the OD-SSB transmission is started. If an indication (“indication C”) is received, the UE measures (or performs L3/RRM measurements using) SSBs based on the OD-SSB configuration when OD-SSB transmission is started/triggered/activated (indicated by RRC/MAC CE/DCI). When OD-SSB transmission is not ongoing (e.g., not yet started or stopped or not triggered or deactivated), the UE measures (or performs L3/RRM measurements using) SSBs based on the SSB configuration in the measurement object. The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for case when the UE measures SSBs based on the SSB configuration in the measurement object and the case when the UE measures SSBs based on the OD-SSB configuration when OD-SSB transmission is started. If neither indication B nor indication C is received, the UE measures (or performs L3/RRM measurements using) SSBs based on the SSB configuration in the measurement object. The UE will report the measurements based on the measurement event/report configuration associated with the measurement object. The measurement event/report configuration associated with measurement object is signaled by the gNB.

Alternately, at operation 2230, in some embodiments, for an SCell, if OD-SSB is configured (e.g., an OD-SSB configuration is received from the gNB) and if the SSB configuration in the measurement object is not the same as the OD-SSB configuration (or if the SSB configuration in the measurement object is not for OD-SSB or if the measurement object does not include an OD-SSB configuration or if the measurement object is for always ON periodic SSBs), the UE assumes that the SSB configuration in the measurement object is for always ON periodic SSBs. If an indication (“indication B”) to measure (or perform L3/RRM measurements using) both OD-SSBs and always ON periodic SSBs is received, the UE measures (or performs L3/RRM measurements using) SSBs based on the SSB configuration in the measurement object, and the UE measures (or performs L3/RRM measurements using) SSBs based on the OD-SSB configuration when OD-SSB transmission is started (indicated by RRC/MAC CE/DCI). The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures only SSBs based on the SSB configuration in the measurement object and case when the UE additionally measures SSBs based on OD-SSB configuration when OD-SSB transmission is started. If indication B is not received, the UE measures (or performs L3/RRM measurements using) SSBs based on the OD-SSB configuration when OD-SSB transmission is started/triggered/activated (indicated by RRC/MAC CE/DCI). When OD-SSB transmission is not ongoing (e.g., not yet started or stopped or not triggered or deactivated), the UE measures (or performs L3/RRM measurements using) SSBs based on the SSB configuration in the measurement object. The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures SSBs based on the SSB configuration in the measurement object and the case when the UE measures SSBs based on the OD-SSB configuration when the OD-SSB transmission is started.

Alternately, at operation 2230, in some embodiments, for an SCell, if OD-SSB is configured (e.g., an OD-SSB configuration is received from the gNB) and if the SSB configuration in the measurement object is not the same as the OD-SSB configuration (or if the SSB configuration in the measurement object is not for OD-SSB or if the measurement object does not include an OD-SSB configuration or if the measurement object is for always ON periodic SSBs), the UE assumes that the SSB configuration in the measurement object is for always ON periodic SSBs. If an indication (“indication B”) to measure (or perform L3/RRM measurements using) both OD-SSBs and always ON periodic SSBs is received, the UE measures (or performs L3/RRM measurements using) SSBs based on the SSB configuration in the measurement object and the UE measures (or performs L3/RRM measurements using) SSBs based on the OD-SSB configuration when OD-SSB transmission is started (indicated by RRC/MAC CE/DCI). The UE will report the measurements based on the measurement event/report configuration associated with the measurement object. The measurement event/report configuration associated with the measurement object is signaled by the gNB. In some embodiments, the measurement object may be associated with two different reporting configurations, wherein the reporting configuration is different for the case when the UE measures only SSBs based on the SSB configuration in the measurement object and the case when the UE additionally measures SSBs based on the OD-SSB configuration when OD-SSB transmission is started. If indication B is not received, the UE measures (or performs L3/RRM measurements using) SSBs based on the SSB configuration in the measurement object. The UE will report the measurements based on the measurement event/report configuration associated with the measurement object. Measurement event/report configuration associated with measurement object is signaled by gNB.

Alternately, at operation 2230, in some embodiments, for an SCell, if OD-SSB is configured (e.g., an OD-SSB configuration is received from the gNB) and if the SSB configuration in the measurement object is not the same as the OD-SSB configuration (or if the SSB configuration in measurement object is not for OD-SSB or if measurement object does not include OD-SSB configuration or if measurement object is for always ON periodic SSBs), the UE assumes that the SSB configuration in the measurement object is for always ON periodic SSBs. If an indication (“indication C”) is received, the UE measures (or performs L3/RRM measurements using) SSBs based on the OD-SSB configuration when OD-SSB transmission is started/triggered/activated (indicated by RRC/MAC CE/DCI). When OD-SSB transmission is not ongoing (e.g., not yet started or stopped or not triggered or deactivated), the UE measures (or performs L3/RRM measurements using) SSBs based on the SSB configuration in measurement object. The UE will report the measurements based on a measurement event/report configuration associated with the measurement object. The measurement event/report configuration associated with measurement object is signaled by the gNB. In some embodiments, the measurement object may be associated with two different reporting configurations, wherein the reporting configuration is different for case when the UE measures SSBs based on the SSB configuration in the measurement object and the case when the UE measures SSBs based on the OD-SSB configuration when OD-SSB transmission is started. If indication C is not received, the UE measures (or performs L3/RRM measurements using) SSBs based on the SSB configuration in the measurement object. The UE will report the measurements based on the measurement event/report configuration associated with the measurement object. The measurement event/report configuration associated with the measurement object is signaled by the gNB.

Although FIG. 22 illustrates one example procedure 2200 for operating a UE, various changes may be made to FIG. 22. For example, while shown as a series of operations, various operations in FIG. 22 could overlap, occur in parallel, occur in a different order, occur any number of times, be omitted, or replaced by other operations.

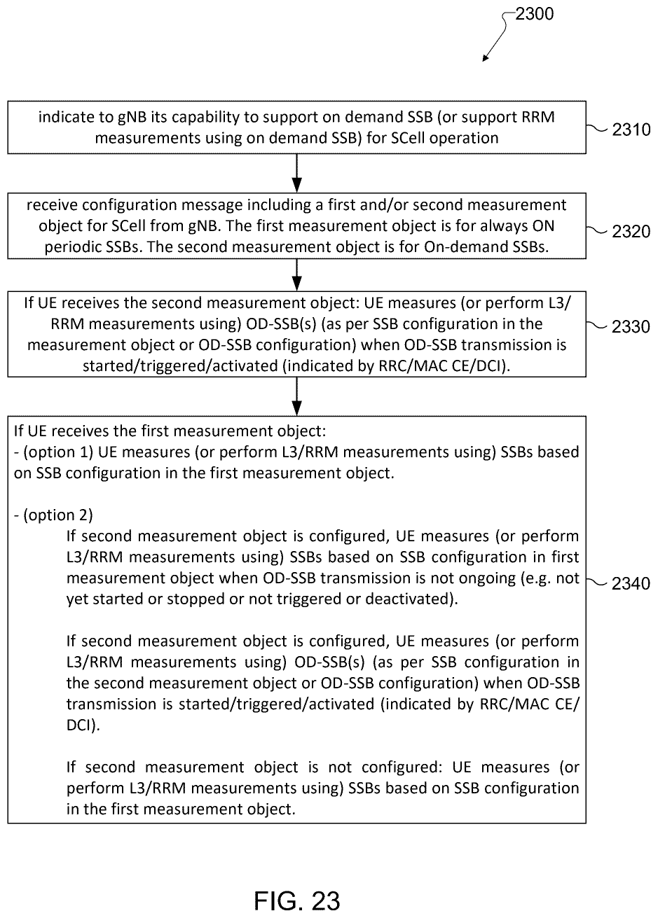

FIG. 23 illustrates another example procedure 2300 for operating a UE according to embodiments of the present disclosure. An embodiment of the method illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a method for operating a UE could be used without departing from the scope of this disclosure.

In the example of FIG. 23, procedure 2300 begins at operation 2310. At operation 2310, in some embodiments, a UE (such as UE 116 of FIG. 1) may indicate the UE's capability to support on demand SSB transmission for SCell operation. This capability can be per UE capability or this capability can be per frequency capability or this capability can be per frequency band capability or this capability can be per frequency range (FR1, FR2-1, FR2-2, FR3, etc.) capability. In some embodiments, the UE may indicate the UE's capability to support RRM measurements using on demand SSB transmission for SCell operation. This capability can be per UE capability or this capability can be per frequency capability or this capability can be per frequency band capability or this capability can be per frequency range (FR1, FR2-1, FR2-2, FR3, etc.) capability.

At operation 2320, a gNB (such as gNB 102 of FIG. 1) sends an RRCReconfiguration message to the UE, wherein the message includes a configuration of one or more SCells. The UE receives the RRCReconfiguration message from the gNB, wherein the message includes the configuration of the one or more SCells.

In some embodiments, the RRCReconfiguration message may indicate whether the gNB supports on demand SSB transmission for configured SCell(s). This indication can be common for all configured SCells or this indication can be per configured SCell. The gNB may indicate support of on demand SSB transmission for zero, one or more configured SCells.

In some embodiments, for a configured SCell for which the gNB supports on demand SSB (OD-SSB) transmission, the gNB may provide/signal (e.g., in the RRCReconfiguration message) the OD-SSB configuration (e.g., SSB frequency, SS periodicity, transmitted SSBs, SSB SCS, etc.) indicating time and frequency location(s) of on demand SSB transmission. This configuration can be per BWP of a configured SCell or can be common for all BWPs of a configured SCell. In some embodiments, a nonCellDefiningSSB IE may be configured in the DL BWP configuration and the network may indicate whether the on-demand SSB configuration is the same as the SSB configuration in nonCellDefiningSSB (or in other words network indicate whether on demand SSB configuration for the DL BWP is the SSB configuration included in nonCellDefiningSSB). Alternately, if on-demand SSB configuration is not signaled in the DL BWP and nonCellDefiningSSB is configured, the UE may apply nonCellDefiningSSB configuration as the on-demand SSB configuration if the SCell supports on-demand SSB.

In some embodiments, for a configured SCell, the gNB may indicate/signal/configure (e.g., the UE receives from the gNB in the configuration message) a first measurement object for measurements (for L3 measurements/RRM measurements). The first measurement object is for always ON periodic SSBs. The first measurement object includes an SSB configuration for always ON periodic SSBs, wherein the configuration includes one or more of an SSB Frequency, SSB Subcarrier Spacing, smtc or SSB periodicity, ssb-ToMeasure (or transmitted SSB[s]) etc. For indicating/signaling this first measurement object of the SCell, a list of measurement objects (each identified by MeasObjectId) may be signaled in an RRCReconfiguration message and a configuration (e.g., in the Serving Cell configuration [ServingCellConfig IE] of the SCell or in the DL BWP configuration of the SCell, the DL BWP configuration is for each DL BWP configured for the SCell) of SCell includes a MeasObjectId of a measurement object in the list. If the MeasObjectId for the first measurement object is present in a downlink BWP and the BWP is activated, the UE uses this measurement object for periodic SSB based measurements. Otherwise, the UE uses the first measurement object indicated by MeasObjectId in the Serving Cell configuration for periodic SSB based measurements.

In some embodiments, for a configured SCell, the gNB may indicate/signal/configure (e.g., the UE receives from the gNB in a configuration message) a second measurement object for measurements (for L3 measurements/RRM measurements). The second measurement object is for On-demand SSBs. The second measurement object may include an SSB configuration for On-demand SSBs, wherein the configuration includes one or more of an SSB Frequency, SSB Subcarrier Spacing, smtc or SSB periodicity, ssb-ToMeasure (or transmitted SSB[s]) etc. If the second measurement object does not include an SSB configuration, the UE uses the OD-SSB configuration received in the configuration of the SCell for this measurement object. For indicating/signaling this second measurement object of the SCell, a list of measurement objects (each identified by MeasObjectId) may be signaled in an RRCReconfiguration message and a configuration (e.g., in the Serving Cell configuration [ServingCellConfig IE] of the SCell or in the DL BWP configuration of the SCell, the DL BWP configuration is for each DL BWP configured for the SCell) of the SCell includes MeasObjectId of a measurement object in the list. If the MeasObjectId for the second measurement object is present in a downlink BWP and the BWP is activated, the UE uses this measurement object for OD-SSB based measurements. Otherwise, the UE uses the second measurement object indicated by MeasObjectId in the Serving Cell configuration for the OD-SSB based measurements. For the second measurement object, the following relationship applies between this measurement object and nonCellDefiningSSB (if configured) in BWP-DownlinkDedicated of the associated downlink BWP: if ssbFrequency is configured, the value of ssbFrequency is the same as the absoluteFrequencySSB in the nonCellDefiningSSB.

In some embodiments, for configured SCell, the gNB may indicate/signal/configure (e.g., the UE receives from the gNB in a configuration message) a first measurement object only or may indicate/signal/configure (e.g., the UE receives from the gNB in a configuration message) a second measurement object or may indicate/signal/configure (e.g., the UE receives from the gNB in a configuration message) both the first measurement object and second measurement object.

At operation 2330, if the UE receives the second measurement object, the UE measures (or performs L3/RRM measurements using) OD-SSB(s) (as per the SSB configuration in the measurement object or OD-SSB configuration) when OD-SSB transmission is started/triggered/activated (indicated by RRC/MAC CE/DCI). The UE will report the measurements based on the measurement event/report configuration associated with the second measurement object. The measurement event/report configuration associated with the measurement object is signaled by the gNB. The UE does not measure (or perform L3/RRM measurements using) SSB(s) or OD-SSBs (as per the SSB configuration in the measurement object or the OD-SSB configuration) when OD-SSB transmission is not ongoing (e.g., not yet started or stopped or not triggered or deactivated).

At operation 2340, in some embodiments (“option 1”), if the UE receives the first measurement object, the UE measures (or performs L3/RRM measurements using) SSBs based on the SSB configuration in the first measurement object. The UE will report the measurements based on the measurement event/report configuration associated with the first measurement object.

Alternately, at operation 2340, in some embodiments (“option 2”), if a second measurement object is configured, the UE measures (or performs L3/RRM measurements using) SSBs based on the SSB configuration in first measurement object when OD-SSB transmission is not ongoing (e.g., not yet started or stopped or not triggered or deactivated). The UE will report the measurements based on the measurement event/report configuration associated with the first measurement object. If a second measurement object is configured, the UE measures (or performs L3/RRM measurements using) OD-SSB(s) (as per the SSB configuration in the second measurement object or OD-SSB configuration) when OD-SSB transmission is started/triggered/activated (indicated by RRC/MAC CE/DCI). The UE will report the measurements based on the measurement event/report configuration associated with the second measurement object. If a second measurement object is not configured, the UE measures (or performs L3/RRM measurements using) SSBs based on the SSB configuration in the first measurement object. The UE will report the measurements based on the measurement event/report configuration associated with the first measurement object.

The gNB can indicate (via RRC or MAC CE or DCI) to the UE whether to perform option 1 or option 2.

Although FIG. 23 illustrates one example procedure 2300 for operating a UE, various changes may be made to FIG. 23. For example, while shown as a series of operations, various operations in FIG. 23 could overlap, occur in parallel, occur in a different order, occur any number of times, be omitted, or replaced by other operations.

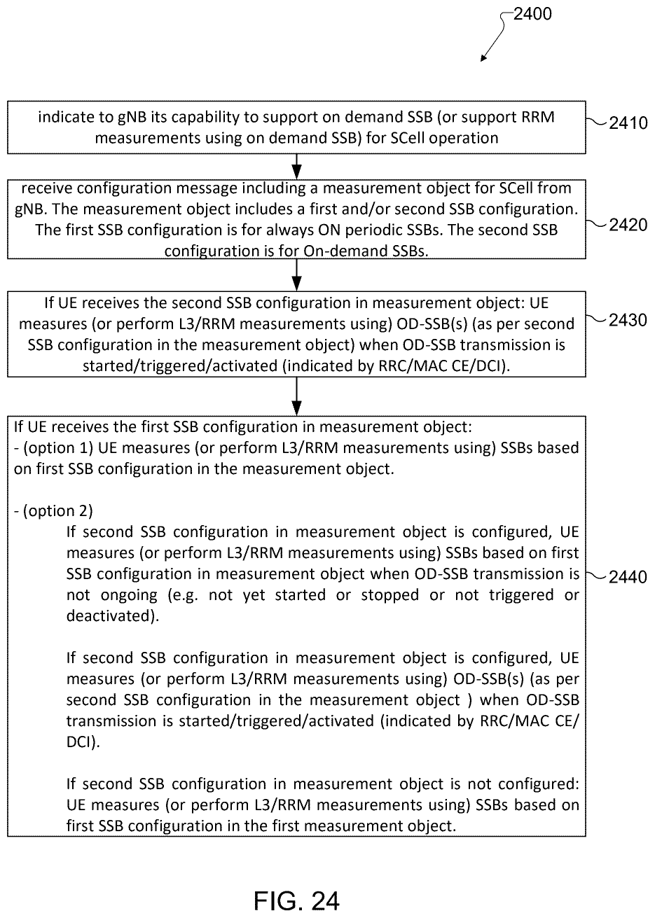

FIG. 24 illustrates another example procedure 2400 for operating a UE according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method for operating a UE could be used without departing from the scope of this disclosure.

In the example of FIG. 24, procedure 2400 begins at operation 2410. At operation 2410, in some embodiments, a UE (such as UE 116 of FIG. 1) may indicate the UE's capability to support on demand SSB transmission for SCell operation. This capability can be per UE capability or this capability can be per frequency capability or this capability can be per frequency band capability or this capability can be per frequency range (FR1, FR2-1, FR2-2, FR3, etc.) capability. In some embodiments, the UE may indicate the UE's capability to support RRM measurements using on demand SSB transmission for SCell operation. This capability can be per UE capability or this capability can be per frequency capability or this capability can be per frequency band capability or this capability can be per frequency range (FR1, FR2-1, FR2-2, FR3, etc.) capability.

At operation 2420, a gNB (such as gNB 102 of FIG. 1) sends an RRCReconfiguration message to the UE, wherein the message includes a configuration of one or more SCells. The UE receives the RRCReconfiguration message from the gNB, wherein the message includes the configuration of the one or more SCells.

In some embodiments, the RRCReconfiguration message may indicate whether the gNB supports on demand SSB transmission for configured SCell(s). This indication can be common for all configured SCells or this indication can be per configured SCell. The gNB may indicate support of on demand SSB transmission for zero, one or more configured SCells.

In some embodiments, for a configured SCell for which the gNB supports on demand SSB (OD-SSB) transmission, the gNB may provide/signal (e.g., in the RRCReconfiguration message) the OD-SSB configuration (e.g., SSB frequency, SS periodicity, transmitted SSBs, SSB SCS, etc.) indicating time and frequency location(s) of on demand SSB transmission. This configuration can be per BWP of a configured SCell or can be common for all BWPs of a configured SCell.

In some embodiments, for a configured SCell, the gNB may indicate/signal/configure (e.g., the UE receives from the gNB in a configuration message) a measurement object for measurements (for L3 measurements/RRM measurements). The measurement object includes a first SSB configuration and/or a second SSB configuration. The first SSB configuration is for always ON periodic SSBs. The second SSB configuration is for On-demand SSBs. The SSB configuration includes one or more of an SSB Frequency, SSB Subcarrier Spacing, smtc or SSB periodicity, ssb-ToMeasure (or transmitted SSB(s)) etc. For indicating/signaling a measurement object of the SCell, a list of measurement objects (each identified by MeasObjectId) may be signaled in an RRCReconfiguration message and a configuration (e.g., in the Serving Cell configuration [ServingCellConfig IE] of the SCell or in the DL BWP configuration of the SCell, the DL BWP configuration is for each DL BWP configured for SCell) of the SCell includes a MeasObjectId of a measurement object in the list. The measurement object of the SCell is the measurement object indicated by the MeasObjectId. If the MeasObjectId is present in a downlink BWP and the BWP is activated, the UE uses this measurement object. Otherwise, the UE uses the first measurement object indicated by the MeasObjectId in the Serving Cell configuration.

At operation 2430, if the UE receives the second SSB configuration in the measurement object (or the OD-SSB configuration is received), the UE measures (or performs L3/RRM measurements using) OD-SSB(s) (as per the second SSB configuration in the measurement object or the OD-SSB configuration) when OD-SSB transmission is started/triggered/activated (indicated by RRC/MAC CE/DCI). The UE does not measure (or perform L3/RRM measurements using) SSB(s) or OD-SSBs (as per the second SSB configuration in the measurement object or OD-SSB configuration) when OD-SSB transmission is not ongoing (e.g., not yet started or stopped or not triggered or deactivated).

At operation 2440, in some embodiments (“option 1”), if the UE receives the first SSB configuration in measurement object, the UE measures (or performs L3/RRM measurements using) SSBs based on first SSB configuration in the measurement object.

Alternately, at operation 2440, in some embodiments (“option 2”), if the UE receives the first SSB configuration in measurement object, if the second SSB configuration in the measurement object is configured (or the OD-SSB configuration is received), the UE measures (or perform L3/RRM measurements using) SSBs based on the first SSB configuration in the measurement object when OD-SSB transmission is not ongoing (e.g., not yet started or stopped or not triggered or deactivated).

If the second SSB configuration in measurement object is configured (or the OD-SSB configuration is received), the UE measures (or performs L3/RRM measurements using) OD-SSB(s) (as per the second SSB configuration in the measurement object or OD-SSB configuration) when OD-SSB transmission is started/triggered/activated (indicated by RRC/MAC CE/DCI). If the second SSB configuration in the measurement object is not configured (the second SSB configuration in the measurement object is not configured and OD-SSB configuration is not received), the UE measures (or performs L3/RRM measurements using) SSBs based on the first SSB configuration in the first measurement object.

The gNB can indicate (e.g., via RRC or MAC CE or DCI) to the UE whether to perform option 1 or option 2.

Although FIG. 24 illustrates one example procedure 2400 for operating a UE, various changes may be made to FIG. 24. For example, while shown as a series of operations, various operations in FIG. 24 could overlap, occur in parallel, occur in a different order, occur any number of times, be omitted, or replaced by other operations.

In some embodiments, a UE receives from a gNB a measurement object for an SCell. The measurement object includes an SSB configuration for always ON periodic SSBs, wherein the configuration includes one or more of an SSB Frequency, SSB Subcarrier Spacing, smtc or SSB periodicity, ssb-ToMeasure (or transmitted SSB(s)) etc. For indicating/signaling the measurement object of the SCell, a list of measurement objects (each identified by MeasObjectId) may be signaled in an RRCReconfiguration message and a configuration of the SCell includes the MeasObjectId of a measurement object in the list. The measurement object of the SCell is the measurement object indicated by the MeasObjectId. The UE receives from the gNB, an OD-SSB configuration for the SCell. The UE measures (or performs L3/RRM measurements using) SSBs based on SSB configuration in the measurement object. The UE measures the always on periodically transmitted SSBs in the SSB based measurement timing configuration (SMTC) duration (the SMTC configuration in the measurement object includes periodicity, offset and duration, the SMTC configuration configures measurement timing configurations [i.e., timing occasions at which the UE measures SSBs]). If there are additionally transmitted SSBs (as per the OD-SSB configuration) in the SMTC duration configured in the measurement object, the UE measures these additionally transmitted SSBs when they are transmitted.

In some embodiments, the UE receives from a gNB a measurement object for an SCell. The measurement object includes an SSB configuration, wherein the configuration includes one or more of an SSB Frequency, SSB Subcarrier Spacing, smtc or SSB periodicity, ssb-ToMeasure (or transmitted SSB(s)) etc. The gNB configures a SMTC according to a future OD-SSB transmission pattern and other SSB configurations for the OD-SSB. The gNB configures an indication “A”, which informs a UE that the UE only performs RRM measurements based on the measurement object when the OD-SSB transmission happens. The UE doesn't perform RRM measurement on the measurement object before the reception of a DCI/RRC message/MAC CE indication of the OD-SSB transmission. The UE performs RRC/L3 measurement using the SMTC/SSB configuration upon the reception of the DCI/RRC message/MAC CE indication to the end of OD-SSB transmission.

In some embodiments, a UE receives from a gNB a measurement object for an SCell. The measurement object includes an SSB configuration for always ON periodic SSB transmissions, wherein the configuration includes one or more of an SSB Frequency, SSB Subcarrier Spacing, first SMTC or SSB periodicity, ssb-ToMeasure (or transmitted SSB[s]) etc. The gNB configures a SMTC according to an always ON periodic SSB transmission pattern. The gNB also configures an indication “B,” which informs a UE that the performs RRM/L3 measurements using this SMTC except when OD-SSB transmissions are started/triggered/activated. In some embodiments (“option 1”), the gNB also configures an indication “B”, which informs a UE that it the UE performs RRM/L3 measurements using this first SMTC except when OD-SSB transmissions are started/triggered/activated. If indication B is received, the UE performs RRM/L3 measurement using this first SMTC in the measurement object before the reception of a DCI/RRC message/MAC CE indication of OD-SSB transmission. The UE goes back to performing RRM/L3 measurement using this first SMTC once the OD-SSB transmission ends. The UE implicitly derives a second SMTC from the configured the OD-SSB transmission pattern and performs RRC/L3 measurement using the second SMTC upon the reception of the DCI/RRC message/MAC CE indication to the end of OD-SSB transmission. Alternately, the second SMTC for the OD-SSB transmission pattern may be configured in the measurement object and the UE performs RRC/L3 measurement using the second SMTC upon the reception of the DCI/RRC message/MAC CE indication to the end of OD-SSB transmission. Alternately, in some embodiments, (option 2), the UE performs RRM/L3 measurement using this first SMTC in the measurement object before the reception of a DCI/RRC message/MAC CE indication of the OD-SSB transmission. The UE goes back to performing RRM/L3 measurement using this first SMTC once the OD-SSB transmission ends. The UE implicitly derives a second SMTC from the configured OD-SSB transmission pattern and performs RRC/L3 measurement using the second SMTC upon the reception of the DCI/RRC message/MAC CE indication to the end of OD-SSB transmission. Alternately, the second SMTC for the OD-SSB transmission pattern may be configured in the measurement object and the UE performs RRC/L3 measurement using the second SMTC upon the reception of the DCI/RRC message/MAC CE indication to the end of OD-SSB transmission.

In some embodiments, for an SCell, the UE performs RRM/L3 measurements based on OD-SSB, if always ON periodic SSB(s) are not configured in the SCell and OD-SSBs are configured in the SCell. In some embodiments, for an SCell, the UE performs RRM/L3 measurements based on OD-SSB if always ON periodic SSB(s) are not configured in the SCell and OD-SSBs are configured in the SCell and an indication to ‘perform RRM/L3 measurements based on OD-SSB’ is received from the gNB.

In some embodiments, for an SCell, the UE performs RRM/L3 measurements based on always ON periodic SSB(s)+RRM/L3 measurements based on OD-SSB (when configured and transmitted in the SCell) if always ON periodic SSB(s) are configured in the SCell and OD-SSBs are configured in the SCell. In some embodiments, for an SCell, the UE performs RRM/L3 measurements based on always ON periodic SSB(s)+RRM/L3 measurements based on OD-SSB (when configured and transmitted in the SCell) if always ON periodic SSB(s) are configured in the SCell and OD-SSBs are configured in the SCell and an indication to ‘perform RRM/L3 measurements based on OD-SSB in addition to always ON periodic SSB(s)’ is received from the gNB.

In some embodiments, for an SCell, the UE performs RRM/L3 measurements based on always ON periodic SSB(s) when OD-SSBs are not transmitted (started/activated/triggered) and RRM/L3 measurements based on OD-SSB (if configured) when OD-SSBs are transmitted (started/activated/triggered), if always ON periodic SSB(s) are configured in the SCell and OD-SSBs are configured in the SCell. In some embodiments, for an SCell, the UE performs RRM/L3 measurements based on always ON periodic SSB(s) when OD-SSBs are not transmitted and RRM/L3 measurements based on OD-SSB (when configured and transmitted in the SCell) when OD-SSBs are transmitted (started/activated/triggered), if always ON periodic SSB(s) are configured in the SCell and OD-SSBs are configured in the SCell and an indication to ‘perform RRM/L3 measurements based on OD-SSB when transmitted and perform RRM/L3 measurements based ON periodic SSB(s) when OD-SSBs are not transmitted’, is received from the gNB.

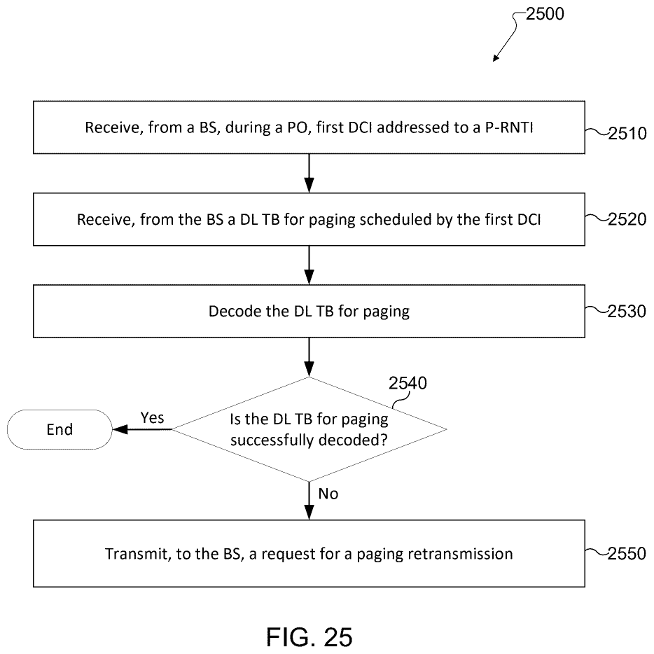

FIG. 25 illustrates an example method 2500 for paging reception and transmission according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a method for paging reception and transmission could be used without departing from the scope of this disclosure.

In the example of FIG. 25, method 2500 begins at step 2510. At step 2510, a UE (such as UE 116 of FIG. 1) receives, from a BS (such as gNB 102 of FIG. 1), during a PO, first DCI addressed to a P-RNTI.

At step 2520, the UE receives, from the BS, a DL TB for paging scheduled by the first DCI.

At step 2530, the UE decodes the DL TB for paging.

At step 2540, the UE determines whether the DL TB for paging is successfully decoded. If the DL TB for paging is successfully decoded, method 2500 ends. If the DL TB for paging is not successfully decoded, method 2500 proceeds to step 2550.

At step 2550, the UE transmits, to the BS, a request for a paging retransmission.

In some embodiments, the UE may received, from the BS, UL resource information for transmitting the request for the paging retransmission. In these embodiments, the request for the paging retransmission may be transmitted based on the UL resource information. In some embodiments, the UL resource information may be received in one of the first DCI, SI, or an RRC message.

In some embodiments, the request for paging retransmission may be transmitted in a UL resource corresponding with an SSB with an SS-RSRP above a threshold.

In some embodiments, in response to transmitting the request for the paging retransmission, the UE may receive a retransmission of the DL TB for paging in a DL resource indicated in the first DCI.

In some embodiments, in response to transmitting the request for the paging retransmission, the UE may receive a retransmission of the DL TB for paging in a predetermined time slot. In some embodiments, the predetermine time slot may be one of (i) a time slot relative to a reception time slot of the first DCI, (ii) a time slot relative to a reception time slot of the DL TB for paging, and (iii) a time slot relative to a transmission time slot of the request for the paging retransmission.

In some embodiments, in response to transmitting the request for the paging retransmission, the UE may receive, from the BS, within a predetermined time window, second DCI including information for receiving a retransmission of the DL TB for paging.

In some embodiments, the PO may comprise a plurality of sets of PMOs, and the first DCI may be received within a PMO of a first set of PMOs of the plurality of sets of PMOs. In these embodiments, in response to transmitting the request for the paging retransmission, the UE may receive, from the BS, during the PO, second DCI addressed to the P-RNTI. The UE may also receive, from the BS, a retransmission of the DL TB for paging scheduled by the second DCI. The UE may receive the second DCI within a PMO of a second set of PMOs of the plurality of sets of PMOs, and the second set of PMOs may occur after the first set of PMOs.

In some embodiments, the PO may be a first PO. In these embodiments, in response to transmitting the request for the paging retransmission, the UE may determine a second PO for receiving a second DCI, and the second DCI may schedule a retransmission of the DL TB for paging. The UE may also determine a PO index for the retransmission, receive the second DCI in the second PO, and receive the retransmission based on the PO index for the retransmission.

Although FIG. 25 illustrates one example method 2500 for paging reception and transmission, various changes may be made to FIG. 25. For example, while shown as a series of steps, various steps in FIG. 25 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS), during a paging occasion (PO), first downlink control information (DCI) addressed to a paging radio network temporary identifier (P-RNTI); and
receive, from the BS, a downlink (DL) transport block (TB) for paging scheduled by the first DCI; and
a processor operably coupled to the transceiver, the processor configured to:
decode the DL TB for paging;
determine whether the DL TB for paging is successfully decoded; and
in response to a determination that the DL TB for paging is not successfully decoded, cause the transceiver to transmit, to the BS, a request for a paging retransmission.

2. The UE of claim 1, wherein:
the transceiver is further configured to receive, from the BS, uplink (UL) resource information for transmitting the request for the paging retransmission; and
the request for the paging retransmission is transmitted based on the UL resource information.

3. The UE of claim 2, wherein the UL resource information is received in one of:
the first DCI;
system information (SI); and
a radio resource control (RRC) message.

4. The UE of claim 1, wherein the transceiver is further configured to transmit the request for paging retransmission in a UL resource corresponding with a synchronization signal block (SSB) with a synchronization signal reference signal received power (SS-RSRP) above a threshold.

5. The UE of claim 1, wherein the transceiver is further configured to, in response to transmitting the request for the paging retransmission, receive a retransmission of the DL TB for paging in a DL resource indicated in the first DCI.

6. The UE of claim 1, wherein the transceiver is further configured to, in response to transmitting the request for the paging retransmission, receive a retransmission of the DL TB for paging in a predetermined time slot.

7. The UE of claim 6, wherein the predetermined time slot is one of:
a time slot relative to a reception time slot of the first DCI;
a time slot relative to a reception time slot of the DL TB for paging; and
a time slot relative to a transmission time slot of the request for the paging retransmission.

8. The UE of claim 1, wherein the transceiver is further configured to, in response to transmitting the request for the paging retransmission, receive, from the BS, within a predetermined time window, second DCI including information for receiving a retransmission of the DL TB for paging.

9. The UE of claim 1, wherein:
the PO comprises a plurality of sets of physical downlink control channel (PDCCH) monitoring occasions (PMOs);
the first DCI is received within a PMO of a first set of PMOs of the plurality of sets of PMOs;
the transceiver is further configured to:
in response to transmitting the request for the paging retransmission, receive, from the BS, during the PO, second DCI addressed to the P-RNTI; and
receive, from the BS, a retransmission of the DL TB for paging scheduled by the second DCI; and
the second DCI is received within a PMO of a second set of PMOs of the plurality of sets of PMOs, the second set of PMOs occurring after the first set of PMOs.

10. The UE of claim 1, wherein:
the PO is a first PO;
the processor is further configured to, in response to the transceiver transmitting the request for the paging retransmission:
determine a second PO for receiving a second DCI, the second DCI scheduling a retransmission of the DL TB for paging; and
determine a PO index for the retransmission; and
the transceiver is further configured to:
receive the second DCI in the second PO; and
receive the retransmission based on the PO index for the retransmission.

11. A method of operating a user equipment (UE), the method comprising:
receiving, from a base station (BS), during a paging occasion (PO), first downlink control information (DCI) addressed to a paging radio network temporary identifier (P-RNTI);
receiving, from the BS, a downlink (DL) transport block (TB) for paging scheduled by the first DCI;
decoding the DL TB for paging;
determining whether the DL TB for paging is successfully decoded; and
in response to a determination that the DL TB for paging is not successfully decoded, transmitting, to the BS, a request for a paging retransmission.

12. The method of claim 11, further comprising receiving, from the BS, uplink (UL) resource information for transmitting the request for the paging retransmission,
wherein the request for the paging retransmission is transmitted based on the UL resource information.

13. The method of claim 12, wherein the UL resource information is received in one of:
the first DCI;
system information (SI); and
a radio resource control (RRC) message.

14. The method of claim 11, wherein the request for paging retransmission is transmitted in a UL resource corresponding with a synchronization signal block (SSB) with a synchronization signal reference signal received power (SS-RSRP) above a threshold.

15. The method of claim 11, further comprising, in response to transmitting the request for the paging retransmission, receiving a retransmission of the DL TB for paging in a DL resource indicated in the first DCI.

16. The method of claim 11, further comprising, in response to transmitting the request for the paging retransmission, receiving a retransmission of the DL TB for paging in a predetermined time slot.

17. The method of claim 16, wherein the predetermined time slot is one of:
a time slot relative to a reception time slot of the first DCI;
a time slot relative to a reception time slot of the DL TB for paging; and
a time slot relative to a transmission time slot of the request for the paging retransmission.

18. The method of claim 11, further comprising, in response to transmitting the request for the paging retransmission, receiving, from the BS, within a predetermined time window, second DCI including information for receiving a retransmission of the DL TB for paging.

19. The method of claim 11, wherein:
the PO comprises a plurality of sets of physical downlink control channel (PDCCH) monitoring occasions (PMOs);
the first DCI is received within a PMO of a first set of PMOs of the plurality of sets of PMOs;
the method further comprises:
in response to transmitting the request for the paging retransmission, receiving, from the BS, during the PO, second DCI addressed to the P-RNTI; and
receiving, from the BS, a retransmission of the DL TB for paging scheduled by the second DCI; and
the second DCI is received within a PMO of a second set of PMOs of the plurality of sets of PMOs, the second set of PMOs occurring after the first set of PMOs.

20. The method of claim 11, wherein:
the PO is a first PO; and
the method further comprises, in response to transmitting the request for the paging retransmission:
determining a second PO for receiving a second DCI, the second DCI scheduling a retransmission of the DL TB for paging;
determining a PO index for the retransmission;
receiving the second DCI in the second PO; and
receiving the retransmission based on the PO index for the retransmission.
